(19) United States
(12) Patent Application Publication
(10) Pub. No.: US 2008/0208710 A1
(43) Pub. Date: Aug. 28, 2008

(54) Commodity Trade Assisting System and Computer Program

(75) Inventors: Tetsuya Taguchi, Tokyo (JP); Masahiro Mizuno, Tokyo (JP)

Correspondence Address: PAUL A. GUSS;PAUL A. GUSS ATTORNEY AT LAW, 775 S 23RD ST FIRST FLOOR SUITE 2, ARLINGTON, VA, 22202, US

(73) Assignee: U-SHOP DIGITALLINK CO., LTD., Tokyo (JP)

(21) Appl. No.: 11/573,575

(22) PCT Filed: Aug. 30, 2005
(86) PCT No.: PCT/JP05/15759

§ 371 Date: Feb. 12, 2007

(30) Foreign Application Priority Data
Sep. 3, 2004 (JP) 2004-256852
Oct. 8, 2004 (JP) 2004-296205

(51) Int. Cl. G06Q 30/00

(52) U.S. Cl. 705/27

(57) ABSTRACT

A commodity trade assisting system, for assisting a shop in exhibiting a commodity traded at the shop in a virtual shop and managing it, includes: a communication unit for communicating with a shop terminal which records and manages information on the commodity over a network; a database for storing commodity information sent from the shop terminal as information on the commodity to be sold over the network and received by the communication unit; and an application server (AS) having a function of preparing and posting explanation and other reports about the commodity shown on a commodity guide page of the virtual shop with reference to the commodity information sent from the shop terminal and received by the communication unit and a function of transmitting a signal representing a request to send back information on the commodity to be sold over the network at predetermined time intervals to the shop terminal, updating the information in the database according to the information sent back from the shop terminal in response to the request, receiving information on an order of the commodity shown on the commodity guide page and ordered, and updating the information in the database according to the order information.

### TECHNICAL FIELD

The present invention relates to a commodity trade assisting system for use in trading various commodities and other commercial transactions. More particularly, the present invention relates to a commodity trade assisting device for realizing the commodity trade assisting system and a computer program for performing the functions of the commodity trade assisting system.

### BACKGROUND ART

In an electronic commerce for trading commodities over the Internet, a lot of shopping malls (virtual shopping malls) are used, each of which is a collection of online shops (virtual shops) with various commodity information posted therefor.

On the other hand, in a shop actually selling commodities (when distinguished from the virtual shop, referred to as “real shop”), a sales management system is used such as a POS (Point of Sales) system which processes commodity information at the point of sales. In this case, a personal computer as a terminal processing unit (hereinafter, referred to as shop terminal) used in the shop stores a business application as means for executing a function of recording commodity information for each commodity to be sold which is traded in the shop and sales information or customer information processed based on the commodity information and for updating the sales information or customer information based on ordered items from the customer, or a function of issuing various slips with reference to the sales information or customer information.

Even for a shop using such sales management system, it is desirable to exhibit commodities in a shopping mall, in other words, to post commodity information in order to increase sales opportunities of the commodities. In the conventional shopping mall, however, an exhibitor or a participant in opening a shop needs to manually upload data in a specified file format according to an exclusive exhibition screen format on a web site provided by a shopping mall manager, independently of the sales management system which is operated and managed in the shop terminal. In addition, there is a need to manage ordering or order reception on an exclusive order reception screen provided by the shopping mall manager similarly.

Furthermore, conventionally, the exhibitor or the like needs to carry out operations or management on an exclusive screen provided by each shopping mall also when showing a commodity (opening a shop) or receiving an order in a plurality of shopping malls. Even if there is a screen of a common specification, it has been impossible to automatically transmit data processed or managed by a shop terminal using a POS system to the plurality of shopping malls in order to show the commodity.

Furthermore, while a conventional business application, particularly, an ASP (Application Service Provider) model exists as a tool for performing a function of exhibition, order reception and placement management or a function of settlement, there has been no business application which provides a function of operating with a POS system. On the other hand, the introduction of a system capable of searching stock in real time in house has imposed a heavy burden in cost for constructing or managing a server and the like.

To cope with this, it may be conceivable to make the existing sales management system perform an additional sales management in the online shop. To that end, however, there is a need to change the business application drastically or to construct another new system, which leads to a huge cost for system development and causes a problem of too heavy burden for a small-scale shop.

Accordingly, there has been suggested a sales management system capable of easily linking an online shop construction and operation system with an existing sales management system (for use in a real shop) without changing the sales management system. It is, as disclosed in a patent document 1 described below, a sales management system capable of linking the online shop construction and the online sales management with the existing sales management system, having a function of preparing a commodity guide page including contents of the object commodities to be exhibited in the online shop, which are arbitrarily selected out of the group of commodities for sale to be traded in the real shop, and a function of updating sales information of the real shop based on commodity order information of an order placed in the online shop.

More specifically, an online shop construction and operation system is constructed in the shop terminal in addition to the existing sales management system for updating the content of a slip detail and total file with reference to input slip data. Thereafter, if a commodity to be sold over the Internet is arbitrarily selected and specified from a commodity master file for storing and managing the commodity information for each commodity for sale to be traded in the real shop at the time when the online shop is constructed, the sales management device may prepare a commodity guide page including information on the selected commodity and transmit it to a shopping mall site. In addition, it may receive the Internet sales order information of the order placed in the online shop and update the content of the slip detail and total file based on the order information.

According to the sales management system with the online shop construction and operation system constructed in the shop terminal as described above, it is possible to easily link the online shop construction and operation system with the existing sales management system for use in the real shop without changing the existing sales management system, whereby the online sales can be added as new sales means. In this case, the commodities to be sold in the real shop can be directly shown as commodities to be sold over the Internet and therefore it becomes possible to prevent an accident such as an absence of a commodity for which an order is received over the Internet or a mismatch of the commodity items. In addition, the sales management system does not require manual input of order information on an online sale and therefore prevents a transcription error, thereby reliably processing an order received over the Internet and enabling reflection of the online sales management on the daily business.

[Patent document 1] Japanese Patent Laid-Open Publication No. 2003-85254

### DISCLOSURE OF THE INVENTION

Where commodities to be traded need to be managed one by one or as a single article (hereinafter, referred to as “single-controlled commodities”) such as used commodities or high-mix low-volume products, however, it is necessary to manage all the commodities individually due to difference in level (condition of the commodity) or price even if they are commodities of the same form or type. Particularly in the case of a used commodity, its laying in stock (purchase or consignment) and selling occur irregularly and only the single article is traded and therefore the rapid management of trade is required for the used commodity. For example, when selling the used commodity, a rapid cancellation of exhibiting commodity is required. If there is a delay (time lag) in updating the information, it causes stockout condition of the commodity which is ordered over the Internet. To prevent such stockout, it is necessary to manage the commodities (stocks) shown in the real shop and the information on the commodities (stocks) exhibited in the virtual shop concurrently. If this management is neglected, the reliability of the online commodity information is lost and it leads to a decrease or loss of places of exhibition in shopping malls, which causes a problem of reducing the sales opportunities.

Regarding this problem, the shop terminal as the sales management system disclosed in the above patent document 1 collectively incorporates order information on the online sales accumulated in an interlocking sales detail file and performs online order inputs with batch processing when an online order input module is started. Thus, it is not adapted to manage the commodities (stocks) in the real shop and the commodity (stock) information in the virtual shop concurrently and therefore it is hard to resolve the problem of the stockout condition described above.

Furthermore, the patent document 1 discloses a technical concept that order information is incorporated whenever an order is placed for the managed online sales and then the online order input module is started to thereby perform online order input processing in real time. In that case, however, the real shop needs to start the online order input module of the terminal (shop terminal) to perform the online order input processing whenever an online order is placed, which increases a processing burden on the real shop. While it is therefore conceivable that the shopping mall site synchronizes the information of the real shop based on the order information, it leads to a burden on the shopping mall site and further it is practically impossible for the shopping mall site to perform information processing of the real shop.

It is an object of the present invention to provide a commodity trade assisting system for achieving commodity management free from the occurrence of stockout when an order is placed and other proper commodity trading, without an increase in burden on neither of the real shop and the shopping mall when commodities traded at the real shop are exhibited in the virtual shop.

According to the present invention, there is provided a commodity trade assisting system for assisting a shop in exhibiting and managing a commodity traded at the shop in a virtual shop, comprising:

communication means for communicating with a terminal of the shop which records and manages information on the commodity over a network;

a database for storing commodity information sent from the terminal as information on the commodity of the shop to be sold over the network and received by the communication means;

commodity report preparation means for preparing and posting explanation and other reports about the commodity shown on a commodity guide page of the virtual shop with reference to the commodity information sent from the terminal and received by the communication means; and

commodity information updating means for transmitting a signal representing a request to send back information the commodity of the shop to be sold over the network at predetermined time intervals (for example, thirty second intervals) from the communication means to the terminal, updating the information in the database according to the information sent back from the terminal in response to the request, receiving an order information of the commodity shown on the commodity guide page and ordered, and updating the information in the database according to the order information.

The present invention includes the embodiments shown in FIG. 1 to FIG. 12.

A commodity trade assisting system 1 according to a first embodiment shown in FIG. 1 performs processing of exhibiting a commodity in a virtual shop, receiving an order, and managing stocks and the like, linking with a sales management system of a shop that trades commodities for sale (new commodities) obtained by ordinary purchase and/or single-controlled commodities such as used commodities (hereinafter, the above commodities are generally referred to as “commodities”). The database for storing information on the commodities stores stock information 11, image information 12, and order reception information 13 as commodity information of an allied shop (hereinafter, referred to as affiliated shop) A as described later. The commodity trade assisting system 1 is connected to a terminal (shop terminal) such as a personal computer (PC) installed in the affiliated shop A via a communication network 2.

The commodity trade assisting system 1 includes a computer storing a program for causing the computer to perform services and processing of assisting the affiliated shop in preparing reports or managing sales of the commodities traded at the shop, and peripheral devices of the computer.

The affiliated shop A is, for example, a real shop of an entrepreneur carrying on the business of selling new commodities or mediating a sale of used commodities. The shop terminal (or a server operating the sales management system) stores stock information 21, image information 22, order reception information 23 as commodity information, and sales information 24. The commodity information synchronizes with information stored in the database of the commodity trade assisting system 1.

For exhibiting the commodities of the affiliated shop A into a virtual shop, the commodity trade assisting system 1 has a function of preparing the explanation or other reports about the commodities and posting them on a commodity guide page of the virtual shop. Such commodity guide page is located in an existing site (hereinafter, referred to as allied site) 6 on the Internet, a web site 10 operated by the commodity trade assisting system 1, or a web site 30 (FIG. 12) dedicated for the affiliated shops operated by a relay device 3 (FIG. 8) described later. The commodity trade assisting system 1 includes means for receiving an order information of a commodity selected by a user of the virtual shop and transmitting the order information to the shop terminal of the affiliated shop A which stores the commodity. The shop terminal updates the stock information of the shop in response to the order information of the commodity.

FIG. 2 shows the details of the commodity information and the like stored in the shop terminal (PC) of the affiliated shop A. More specifically, the shop terminal stores a stock table and a stock status table as the stock information 21, an image management table and an image folder as the image information 22, and an order table as the order reception information 23. In addition, it stores a sales table as the sales information 24.

The stock table includes necessary data on the stock commodities: a commodity number, the category of business (a number designating each category of business), classification (for example, a number indicating a “watch”), a manufacturer (name), model (a number indicating the model), type (type number), and others. The stock status table includes data of the presence or absence of a stock, a quantity, and a manufacturer of each stocked commodity.

The image management table includes a commodity number, a handling shop (name or number), valid (flag), an image size, the presence or absence of an image, and a comment, corresponding to an image folder incorporating and storing commodity images if the commodity information includes image information as described later in the embodiment (FIG. 7).

The order table includes an order number, a commodity number, a customer number, a customer name and address, a price, and the like for an ordered commodity.

The sales table includes an order number, a commodity number, a customer number, a customer name and address, a price, and the like for a sold commodity.

FIG. 3 shows the details of the commodity information stored in the commodity trade assisting system 1. More specifically, the commodity trade assisting system 1 stores a stock table and a stock status table as the stock information 11, an image management table and an image folder as the image information 12, and an order table as the order reception information 13. These tables have the same format as those stored in the shop terminal of the affiliated shop A shown in FIG. 2.

Moreover, as described later (FIG. 12), the database of the commodity trade assisting system 1 also stores a shopping cart 15 in a table format. The shopping cart 15 is made of a table including necessary data on the ordered commodity: a customer ID (number or symbol) and similarly to the above stock table, a commodity number, the category of business (a number designating each category of business), classification (for example, a number indicating a “watch”), a manufacturer, model, type, and others.

The affiliated shop A shown in FIG. 2 performs processing of the commodity information and the like in the following procedure by using the shop terminal:

(1) Laying in a stock of commodities and setting data on the commodity (one or more commodities) in the stock table
(2) Connecting the commodity with a captured image of the commodity as described later with reference to the stock table
(3) Setting image information of the commodity in the image management table
(4) Setting image data of the commodity in the image folder
(5) Transmitting data (stock information) in the stock table and the stock status table to the commodity trade assisting system 1 over the network 2
(6) Writing order information into the order table upon receiving the order information from the commodity trade assisting system 1 over the network 2
(7) Performing sales management based on the data in the order table
(8) Updating the stock status table regarding the ordered commodity (changing the status to “delivered” status indicating that the commodity has already been sold). Replacing data in the updating (data different from its original version which is not updated) is referred to as “differential data.”
(9) Writing data into the sales table and terminating the sales management processing
(10) Transmitting the data (differential data) in the stock status table to the commodity trade assisting system 1 over the network 2 at regular intervals

According to the above sales management system of the affiliated shop A, it is possible to achieve the following functions and advantages such as: a commercial PC can be used as a shop terminal; commodities can be easily managed in terms of a single item or a lot; the annual number of traded items is extremely high (for example, one million); images taken by a digital camera can be easily captured as described later; data can be exchanged in real time to or from the commodity trade assisting system 1 via the communication network; a daily report can be easily made by calculating the sales volume, sales account, or the like; and the analysis can be performed for the sales, stocks, and customers.

FIG. 4 shows the contents of the information processing performed between the shop terminal of the affiliated shop A or the web site 10 and the commodity trade assisting system 1.

The following processing is performed between the shop terminal of the affiliated shop A and the commodity trade assisting system 1:

(1) The affiliated shop A uploads new stock and image information from the stock information 21 and then the commodity trade assisting system 1 registers the stock and image information into the database, by which these data are written into the stock information 11.
(2) The affiliated shop A erases the stock data on a sold commodity from the stock information 21, and the commodity trade assisting system 1 updates the stock data, by which the stock information 11 is updated.
(3) The commodity trade assisting system 1 updates the stock information (reserves the commodity) 11 due to receiving an order from the web site to thereby perform processing of the reservation in the stock data of the stock information 21 in the affiliated shop A.
(4) The affiliated shop A uploads the stock image data from the image information 22 and then the commodity trade assisting system 1 registers the stock image data, by which these data are written into the image information 12.
(5) The commodity trade assisting system 1 searches the order reception information 13 for information on an order from the web site, and the affiliated shop A writes order settlement information based on the information on the order into the order reception information 23.

The following processing is performed between the web site 10 and the commodity trade assisting system 1:

(6) The commodity trade assisting system 1 searches the stock information 11 for stock and image data if necessary or regularly, and the web site 10 obtains and displays the stock and image data.
(7) The web site 10 selects the commodity to be posted on the home page and writes data on the commodity into the shopping cart 15 of the commodity trade assisting system 1. The commodity trade assisting system 1 checks the stock status based on the information of the shopping cart 15.
(8) Upon placement of an order on the web site 10, the commodity trade assisting system 1 updates stock (reserves the commodity) due to the order placement via the web site, generates order information, and then writes it into the order reception information 13.

Next, FIG. 5 shows a second embodiment. The commodity trade assisting system 1 has a function of exhibiting commodities on a plurality of allied sites 6A, 6B, 6C, and so on concurrently besides the web site 10 to support the commodity trade management including order reception and the like for each site.

FIG. 6 shows the contents of the information processing performed among the shop terminal of the affiliated shop A, the virtual shops (the web site and the plurality of allied sites), and the commodity trade assisting system 1 in FIG. 5. In this situation, the following processing is performed between each allied site and the commodity trade assisting system 1 in addition to the processing shown in FIG. 4:

(9) The commodity trade assisting system 1 searches the stock information 11 for stock and image data if necessary or regularly, and the allied site obtains and displays the stock and image data.
(10) Upon placement of an order on the allied site, the commodity trade assisting system 1 updates stock (reserves the commodity) due to the order placement, generates order information, and then writes it into the order reception information 13.

In this embodiment, stock data managed by the sales management system of the affiliated shop A can be shown in a plurality of shopping malls concurrently. On the other hand, regarding order reception, the shop terminal or a server operating the sales management system can automatically update data concurrently shown in other shopping malls by receiving order reception data from one of the shopping malls showing the stock data. Thereby, as for the commodities managed by the sales management system, it is possible to exhibit the commodities and manage order receptions at the plurality of shopping malls concurrently by only one-time registration, which dramatically increases the commodity management opportunities and largely reduces the work loads resulting from exhibiting the commodities to managing the order reception and placement.

Next, in a third embodiment shown in FIG. 7, the affiliated shop A takes an image of each commodity to be exhibited in the virtual shops by using a digital camera 24, captures the image into an image processor 25 such as a PC, and sets it as image information 22 with being associated with data on the commodity concerned. The data of the image information 22 is transferred to the commodity trade assisting system 1 as described above. The commodity trade assisting system 1 has a function of storing the image data of the commodity as the image information 12.

For example, when purchasing a commodity G such as shoes in the affiliated shop A, a purchasing staff performs purchase processing by using the PC of the shop terminal, takes an image of the used commodity by the digital camera 24 and captures the image into the image processor 25, associates it with the data on the purchased commodity obtained from the PC of the shop terminal (the commodity is identified by a bar code), and stores it as the image information 22 by performing the image capturing processing. Thereafter, the image information 22 is transmitted to the commodity trade assisting system 1 connected via the network 2 together with the stock information 21, from which it can be uploaded onto the virtual shops in real time.

In this case, the information processing performed among the shop terminal of the affiliated shop A, the virtual shops (the web site 10 and the allied sites 6), and the commodity trade assisting system 1 is substantially the same as one shown in FIG. 6.

Conventionally, when uploading an image taken by a digital camera online, there has been a need to save the taken image into a personal computer and to adjust the image size or image quality and then upload its image data online together with commodity data. According to this embodiment, however, only by capturing the image taken by the digital camera, the image is automatically processed and saved with a preset image size and image quality, and the image is displayed online in real time with being associated with a commodity code managed with a bar code and image information. This greatly reduces workloads required for performing image processing and uploading the data of commodity and image for exhibiting the commodity in the shopping mall.

Next, in a fourth embodiment shown in FIG. 8, one entrepreneur has a plurality of real shops (for example, affiliated shops A, B, and C of Company X) and the commodity trade assisting system 1 is connected to terminals (shop terminals) such as PCs installed in these shops via the communication network 2 and the relay device 3 composed of an ASP server.

The relay device 3 has a function of posting commodity information of each affiliated shop of the entrepreneur on the home page (HP) of the web site 10 or the allied site 6 and searching the stock information in real time or making settlement. Therefore, the relay device 3 has stock information 31, image information 32, and order reception information 33 similarly to the commodity trade assisting system 1.

FIG. 9 shows a procedure for processing performed by the commodity trade assisting system 1 and the relay device 3 shown in FIG. 8 between the plurality of shop terminals of one entrepreneur and the virtual shops (the web site 10 and the allied sites 6). In this situation, the relay device 3 performs (1) to (5) in the processing shown in FIG. 6. More specifically, the processing is performed as follows:

(1) The affiliated shop A uploads new stock and image information from the stock information 21 and then the relay device 3 registers the stock and image information into the database, by which these data are written into the stock information 31.
(2) The affiliated shop A erases the stock data of a sold commodity from the stock information 21 and the relay device 3 updates the stock data, by which the stock information 31 is updated.
(3) Upon receiving an order from the web site, the commodity trade assisting system 1 and the relay device 3 update the stock information (reserve the commodity) 11 and the stock information 31, respectively, to thereby perform processing of the reservation in the stock data of the stock information 21 in the affiliated shop A.
(4) The affiliated shop A uploads the stock image data from the image information 22 and the relay device 3 registers the stock image data, by which these data are written into the image information 32.
(5) The commodity trade assisting system 1 searches the order information 13 for information on an order from the web site and the relay device 3 also searches the order reception information 33 for the information. The affiliated shop A writes order settlement information based on the information on the order into the order reception information 23.

In addition to the above (1) to (5) and (6) to (10) shown in FIG. 6, the following processing is performed between the commodity trade assisting system 1 and the relay device 3:

(11) Updating the stock information 31 of the relay device 3 and the stock information 11 of the commodity trade assisting system 1
(12) Updating the image information 12 of the commodity trade assisting system 1 associated with the updating of the image information 32 of the relay device 3
(13) Updating the order reception information 33 of the relay device 3 and the order reception information 13 of the commodity trade assisting system 1

Next, in a fifth embodiment shown in FIG. 10, there are a plurality of real shops (hereinafter, the shops are referred to as affiliated shops A, B, C, and so on), and relay devices 3A, 3B, and 3C each composed of an individual ASP server are disposed between shop terminals provided in the real shops and the commodity trade assisting system 1 and are connected to the shop terminals and the commodity trade assisting system via the communication networks 2, respectively. The relay devices 3A, 3B, and 3C have a function of posting commodity information of each affiliated shop on the home page (HP) of the web sites 30A, 30B, and 30C located and managed for the corresponding affiliated shops A, B, and C, respectively, or of searching the stock information in real time or making settlement. Therefore, each relay device has the stock information 31, the image information 32, the order reception information 33, and a shopping cart 35 similarly to the commodity trade assisting system 1.

FIG. 11 shows a procedure for processing performed by the commodity trade assisting system 1 and the relay devices 3A, 3B, and 3C shown in FIG. 10 between the shop terminals of the affiliated shops and the virtual shops (the web site 10 and the allied sites 6). In this situation, in addition to the processing (1) to (13) shown in FIG. 9, each relay device performs the following processing:

(14) The stock information 31 of each relay device is searched for the stock and image data if necessary or regularly, and the web site 30 for each affiliated shop managed by each relay device obtains and displays the stock and image data.
(15) The web site 30 selects a commodity to be posted on the home page and writes the commodity data into the shopping cart 35 of the relay device. Each relay device checks the stock status based on the information on the shopping cart 35.
(16) Upon placement of an order on the web site 30, the relay device updates stock (reserves the commodity) due to the order placement via the web site, generates order information, and then writes it into the order reception information 33.

In this embodiment, commodity information managed by the shop terminal connected to the host server of the sales management system of each affiliated shop is displayed on the home page 30A, 30B, or 30C of the affiliated shop and the commodity information can be retrieved and displayed in real time. More specifically, the commodity information managed with bar codes by the plurality of shop terminals is transmitted to the host server, and the host server can display, retrieve and update only the commodity information managed by the sales management system of each affiliated shop in real time on the home page by judging the commodity information with reference to a management ID allocated to each shop. Thereby, each affiliated shop does not need to voluntarily update the information. It can display the stock information or the like in real time on its home page only by linking the commodity database in the host server.

According to the present invention, there is provided a commodity trade assisting method performed by the above commodity trade assisting system. The method is performed based on a program for causing a computer to perform the functions as a commodity trade assisting business server. A recording medium storing the program is also included in the present invention.

According to the present invention, a stock managed by the sales management system with operations of the shop terminal is also automatically exhibited online concurrently in virtual shops of the shopping mall. Furthermore, the real shop stock and the online exhibition stock are synchronously managed in real time, which drastically reduces the exhibition work and information updating operations. Moreover, if the unit control is adopted in the real shop, the online stock vanishes in real time, which prevents the above stockout condition.

Furthermore, since the commodities can be exhibited online while they are placed in the real shop, the unit control opportunities remarkably increase. In addition, the number of commodities exhibited online can be dramatically increased by exhibiting all the commodities in stock under the sales management in the real shop, a warehouse, and the like.

Since the commodity trade assisting system according to the present invention has a function of linking the sales management system connectable to the commodity trade assisting system or the relay device with the web site as described above, the stock data managed by the sales management system can be provided as exhibition information of the shopping mall without any particular operation. Furthermore, also in the order reception processing, it is possible to automatically update data on commodities concurrently exhibited in another shopping mall by receiving order reception data from the shopping mall in which the commodities are exhibited.

### BRIEF DESCRIPTION OF THE DRAWINGS

FIG. 1 is a diagram showing a first embodiment of the present invention;

FIG. 2 is a diagram showing the details of commodity information stored in a shop terminal of an affiliated shop A shown in FIG. 1;

FIG. 3 is a diagram showing the details of commodity information stored in a commodity trade assisting system shown in FIG. 1;

FIG. 4 is a diagram showing a procedure for processing performed between the shop terminal of the affiliated shop A and a virtual shop via the commodity trade assisting system;

FIG. 5 is a diagram showing a second embodiment;

FIG. 6 is a diagram showing a procedure for processing performed between a shop terminal of an affiliated shop A and a virtual shop via a commodity trade assisting system shown in FIG. 5;

FIG. 7 is a diagram showing a third embodiment;

FIG. 8 is a diagram showing a fourth embodiment;

FIG. 9 is a diagram showing a procedure for processing performed via a commodity trade assisting system shown in FIG. 8;

FIG. 10 is a diagram showing a fifth embodiment;

FIG. 11 is a diagram showing a procedure for processing performed via a commodity trade assisting system shown in FIG. 10;

FIG. 12 is a configuration diagram of a commodity trade system for exhibiting a commodity in an online virtual shop or performing commodity trade management such as receiving an order of the commodity;

FIG. 13 is a diagram showing an example of the screen of an allied site;

FIG. 14 is a diagram showing an example of the screen of a web site operated by the commodity trade assisting system;

FIG. 15 is a diagram showing an example of the screen of a web site operated by a relay device;

FIG. 16 is a diagram showing functions of an application server AS shown in FIG. 12;

FIG. 17 is a flowchart showing a stock search operation performed by the application server AS;

FIG. 18 is a diagram showing an example of a commodity category master stored in a database shown in FIG. 12;

FIG. 19 is a flowchart showing order processing performed by the application server AS;

FIG. 20 is a flowchart showing communication processing of a commodity trade assisting system shown in FIG. 12;

FIG. 21 is a flowchart showing transmission processing of a shop terminal shown in FIG. 12;

FIG. 22 is a flowchart showing receiving processing of the shop terminal shown in FIG. 12;

FIG. 23 is a flowchart showing receiving processing of a relay device shown in FIG. 12;

FIG. 24 is a flowchart showing transmission processing of the relay device shown in FIG. 12.

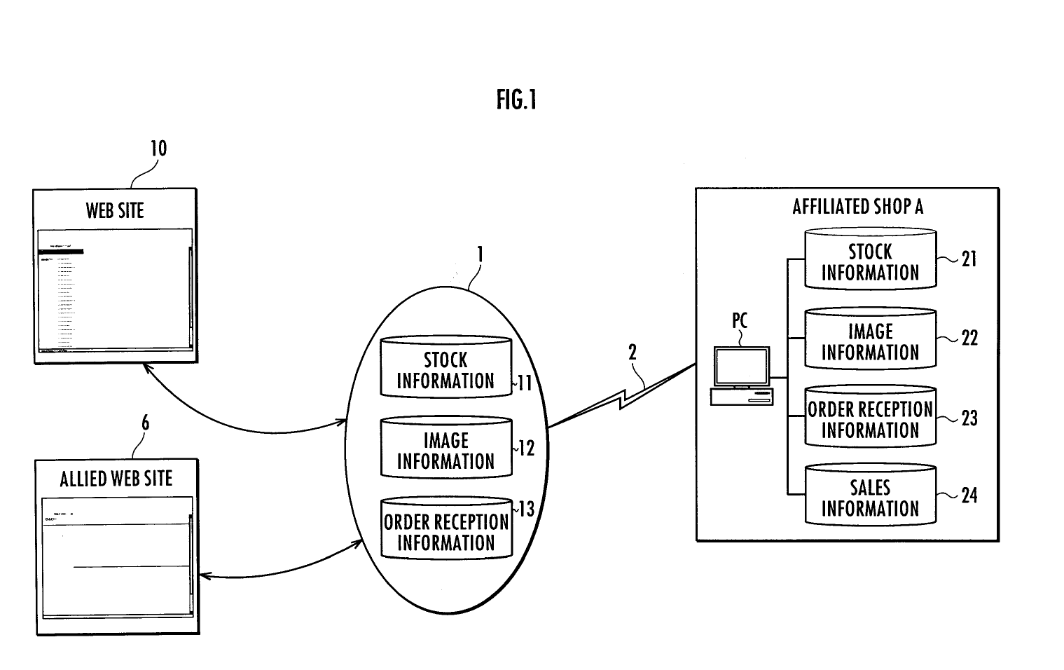

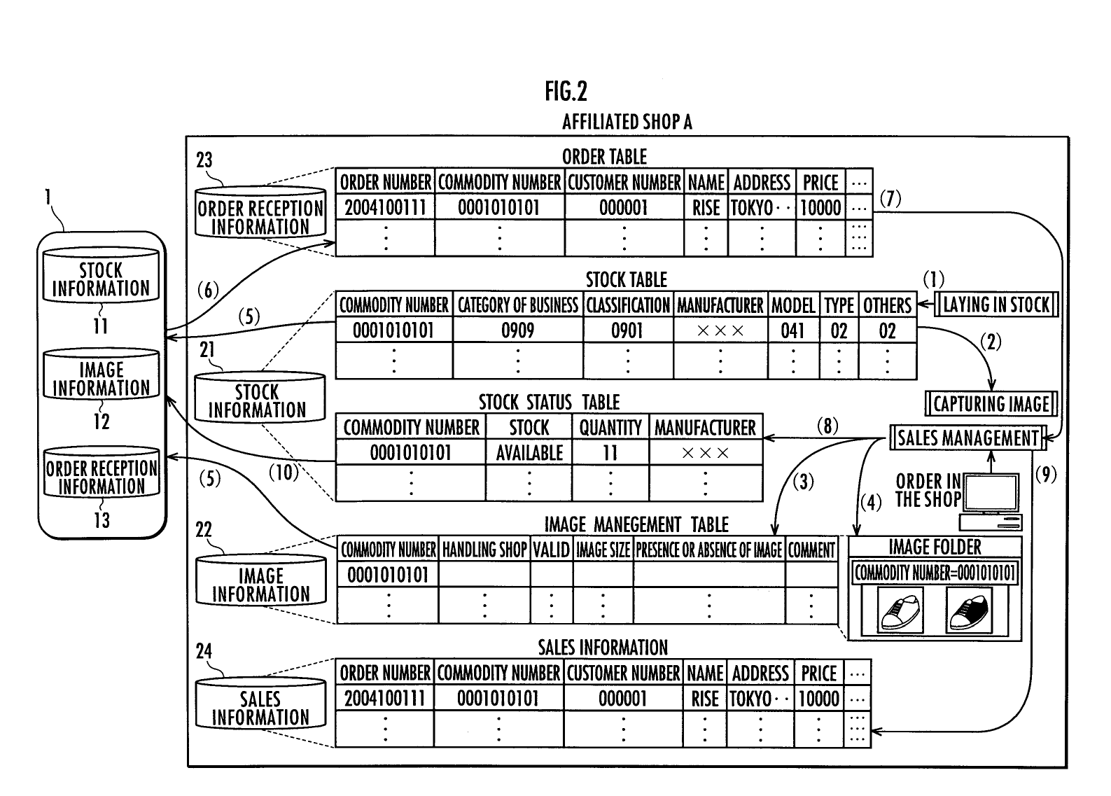

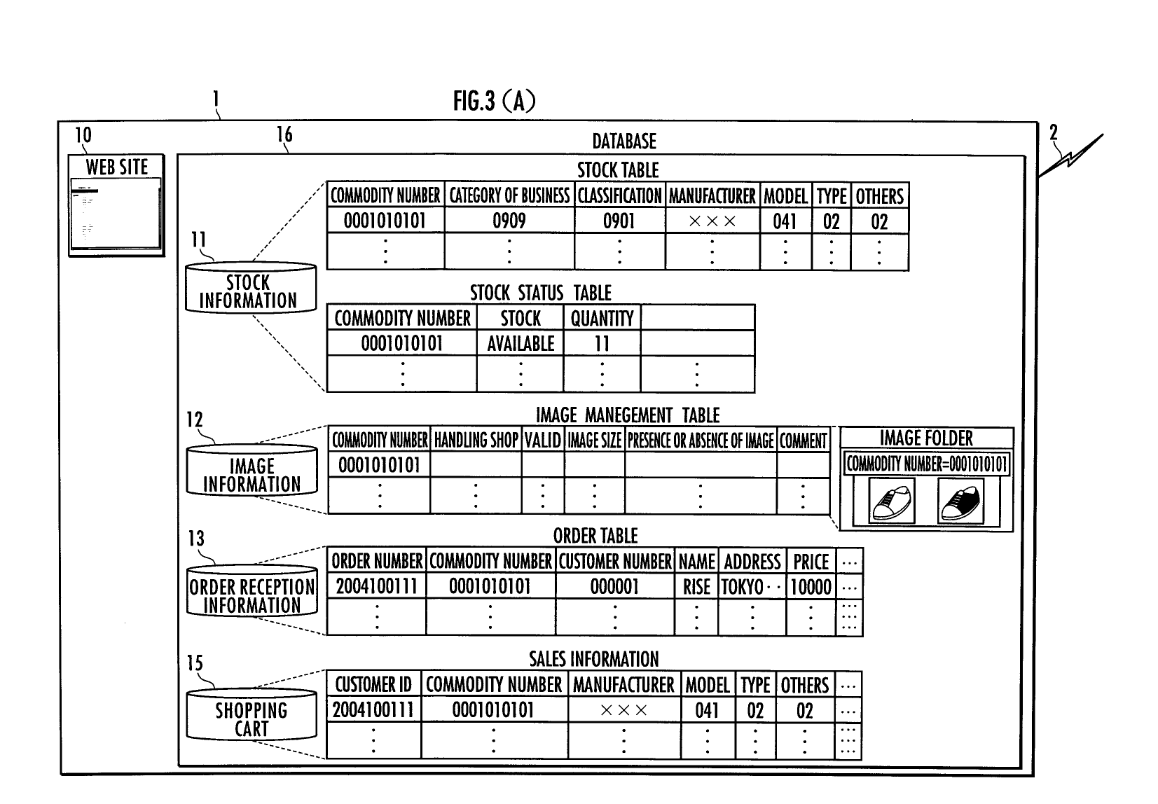

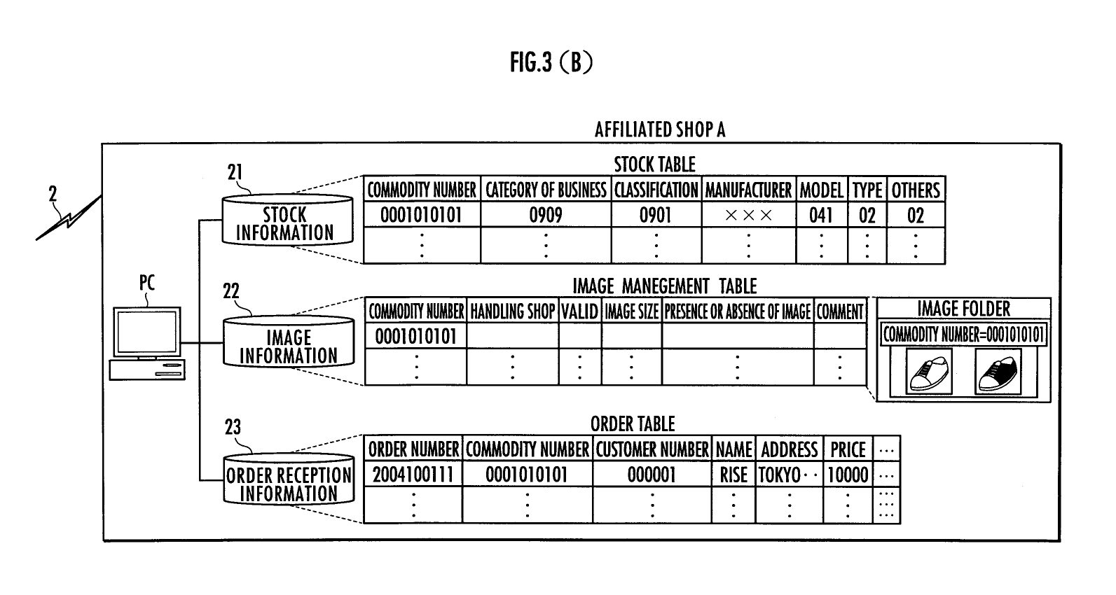

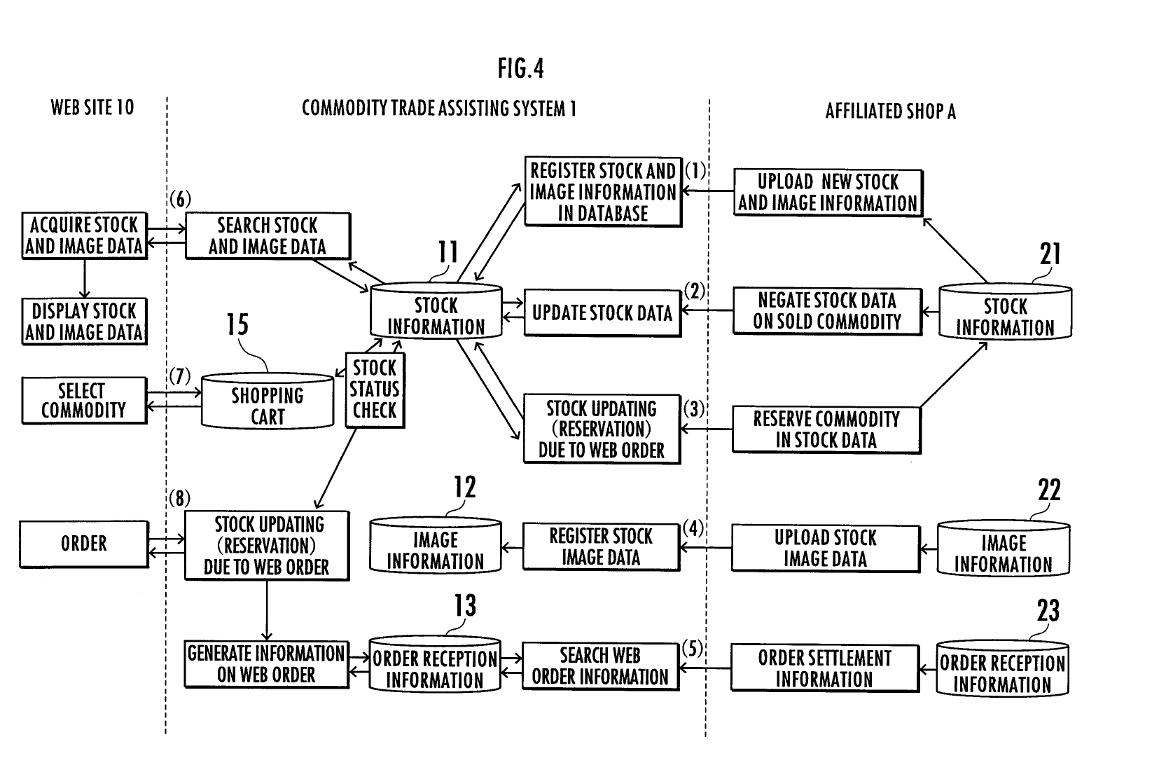

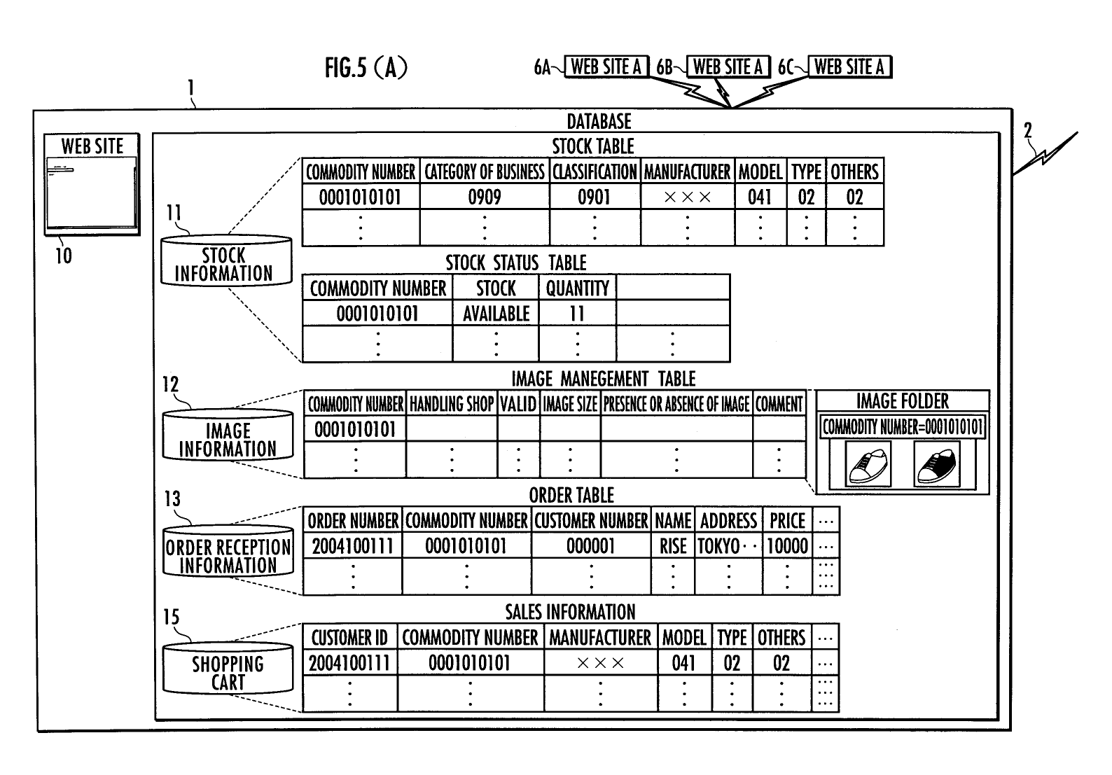

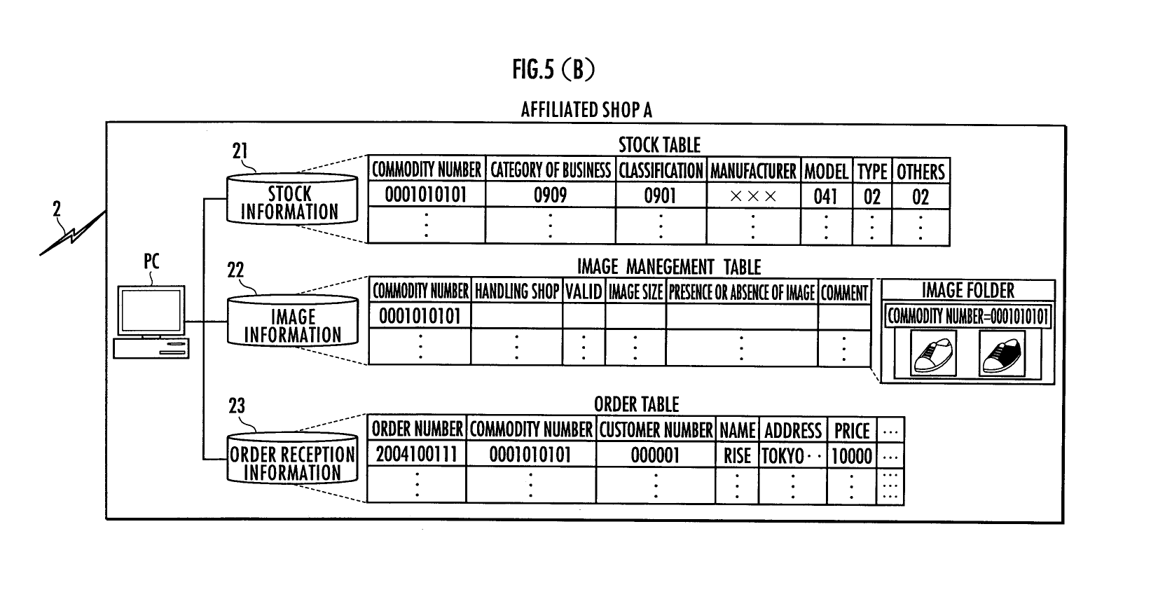

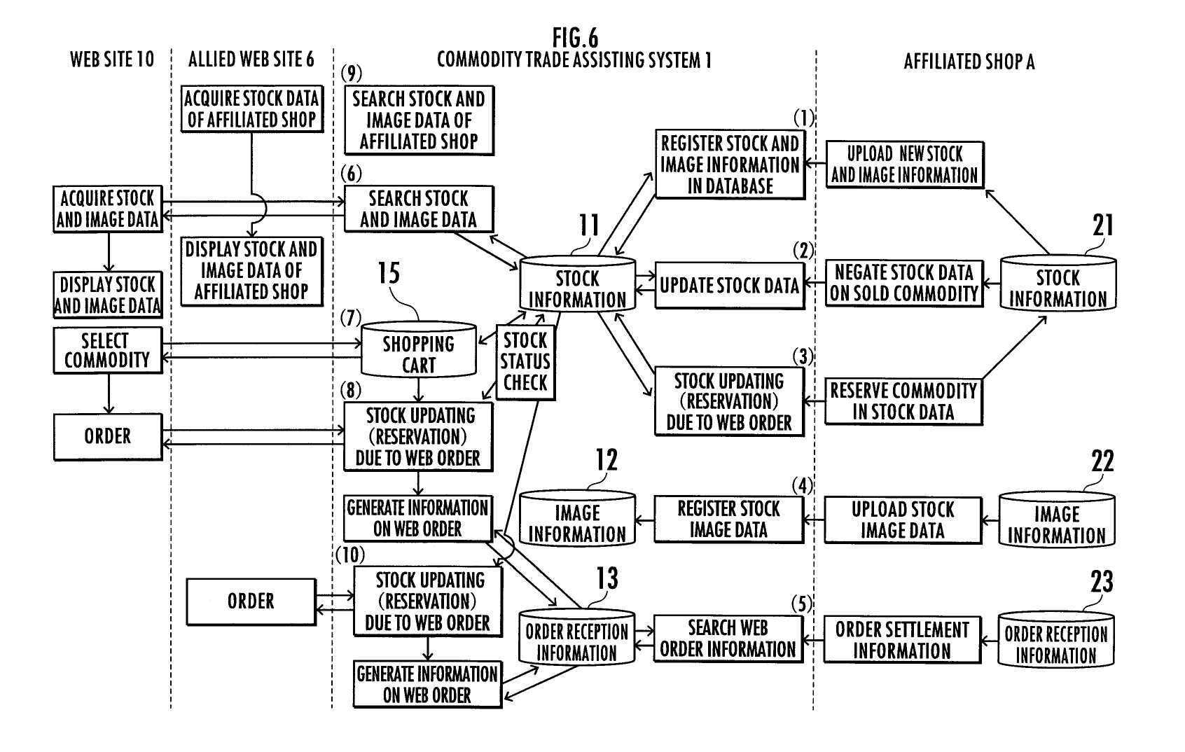

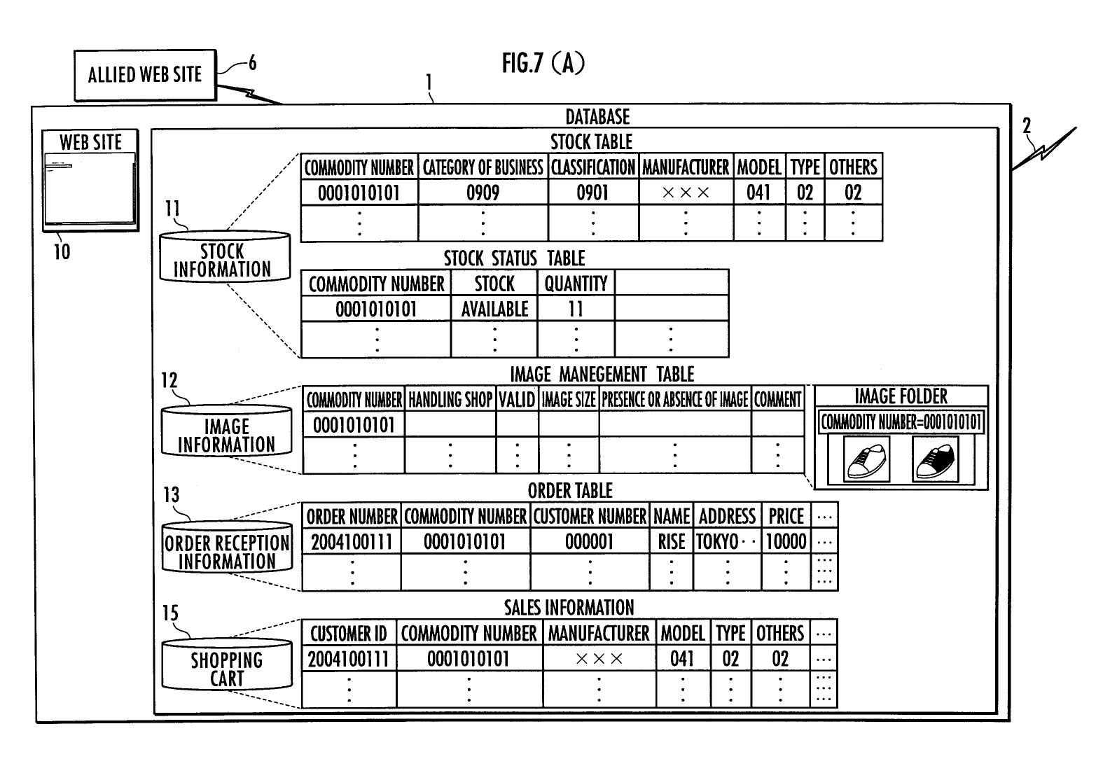

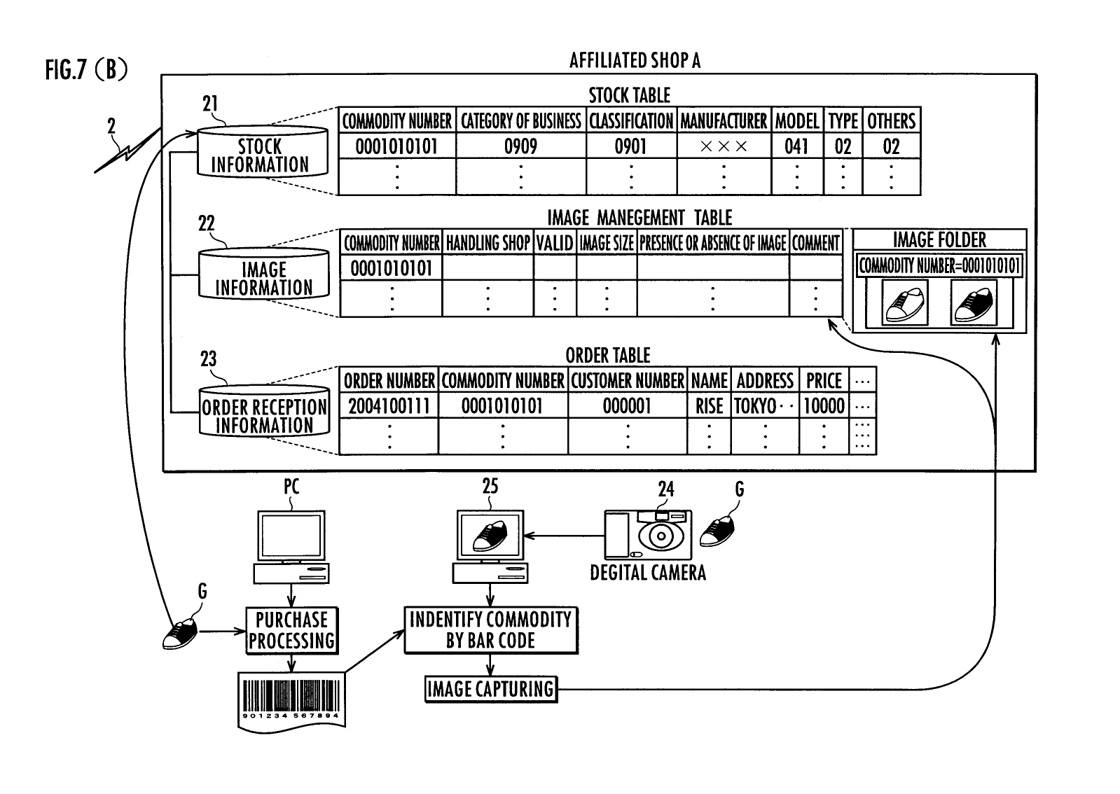

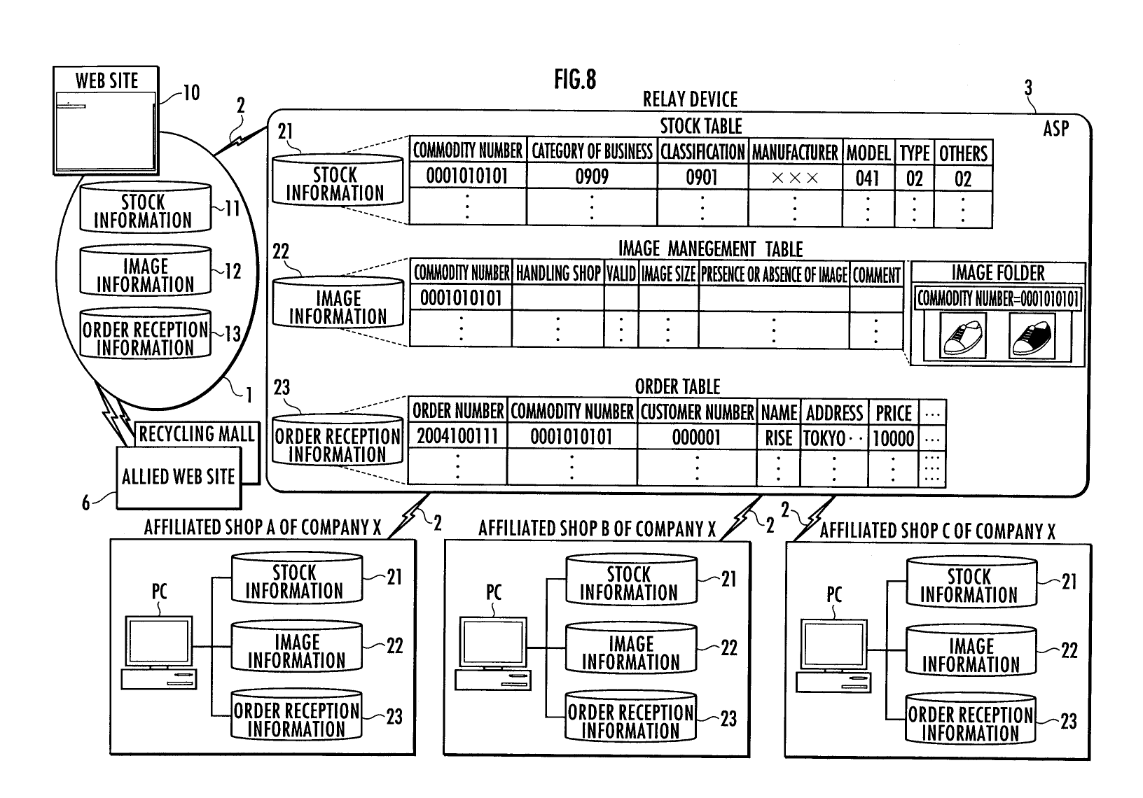

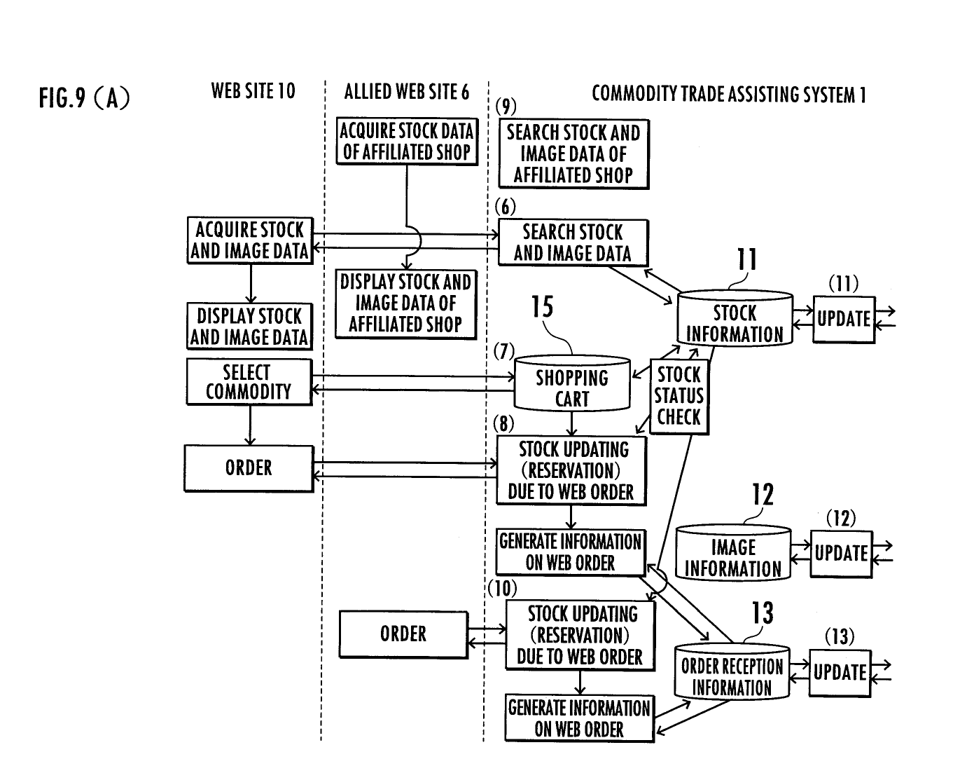

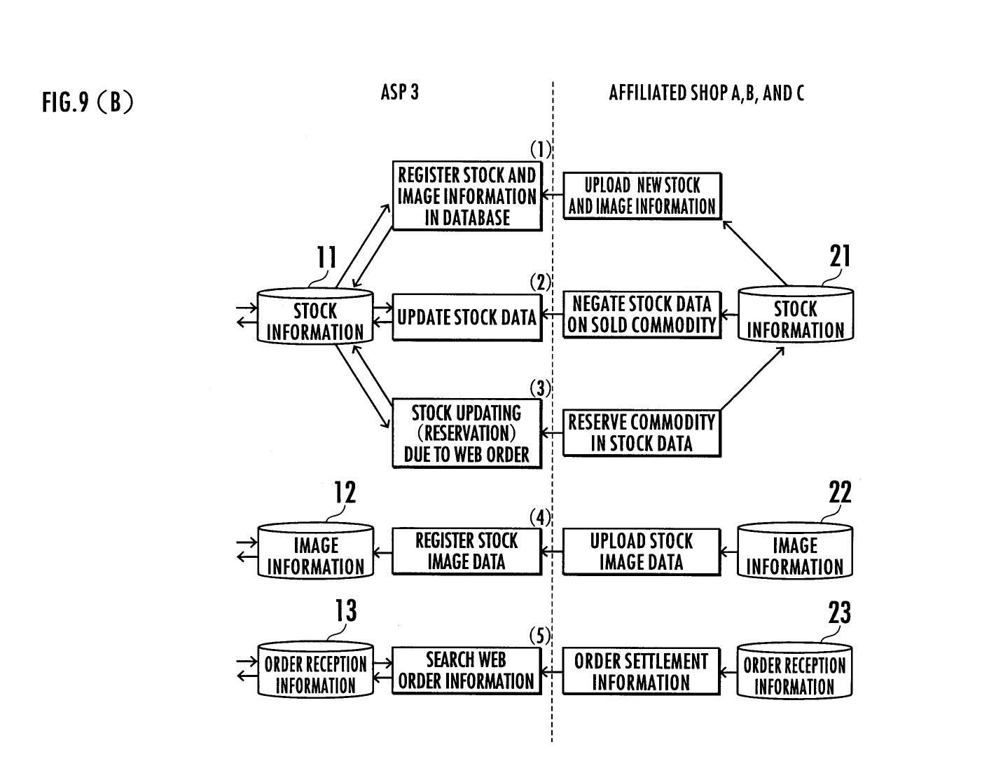

### BEST MODE FOR CARRYING OUT THE INVENTION

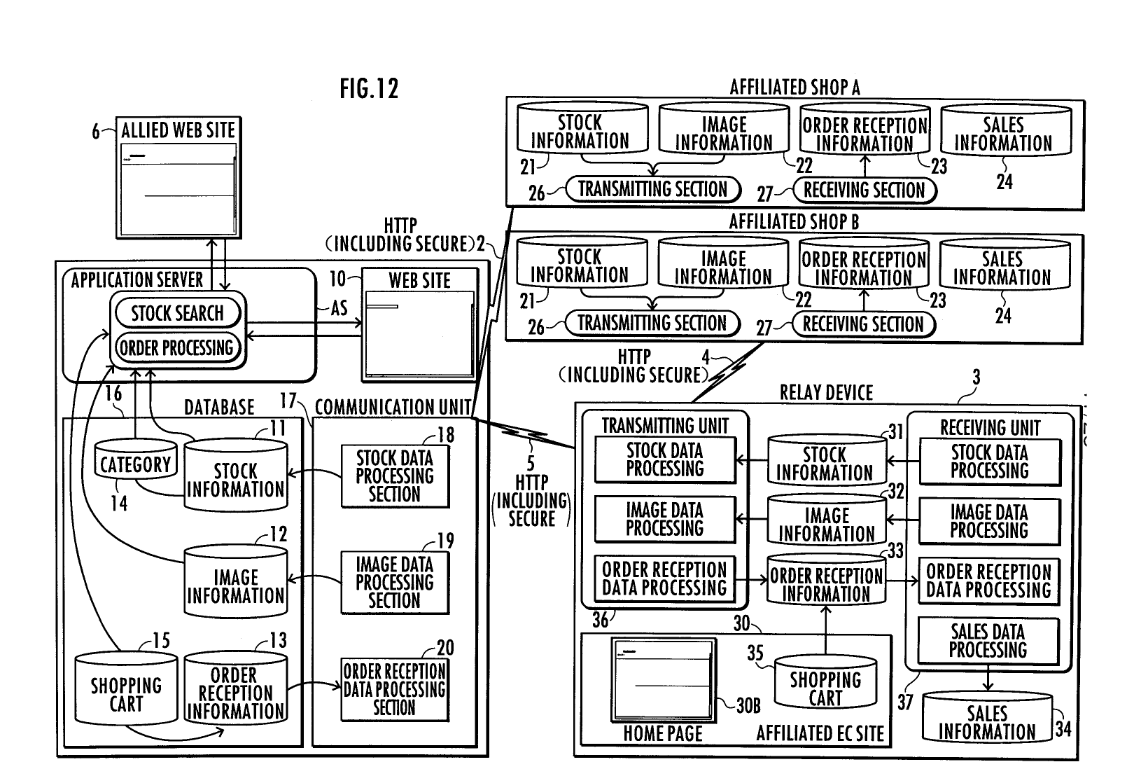

Referring to FIG. 12, there is shown a configuration of a commodity trade system which performs commodity trade management such as exhibition of commodities and reception of orders in online virtual shops by using a commodity trade assisting system according to the present invention.

This commodity trade system performs processing such as exhibiting a commodity in a virtual shop, receiving an order, and managing stock associating with a sales management system of an entrepreneur (client) that sells commodities (new articles) laid in stock or used commodities purchased or that mediates sales of consignments. In the configuration as shown, there are a plurality of shops (affiliated shops A, B, and so on) of this type of entrepreneur and the commodity trade assisting system 1 in this embodiment is connected to terminals (shop terminals) such as PCs installed in these shops via a communication network 2.

The relay device 3 described above is connected to a particular shop (for example, the affiliated shop B), instead of the commodity trade assisting system 1, via a communication network 4. The relay device 3 is configured to perform the same commodity trade assistance as that of the commodity trade assisting system 1 as described later.

The commodity trade assisting system 1 is also connected to the relay device 3 via a communication network 5. The Internet is used as the communication networks 2, 4, and 5 connecting these devices.

The commodity trade assisting system 1 has a function of preparing and posting the explanation and other reports about commodities shown on the commodity guide page of a virtual shop in order to exhibit the commodities of the affiliated shops A, B, and so on in the virtual shop. Such commodity guide page is prepared in an existing online shopping mall (allied site) 6, a web site 10 operated by the commodity trade assisting system 1, or a web site 30 dedicated for specific affiliated shops operated by the relay device 3.

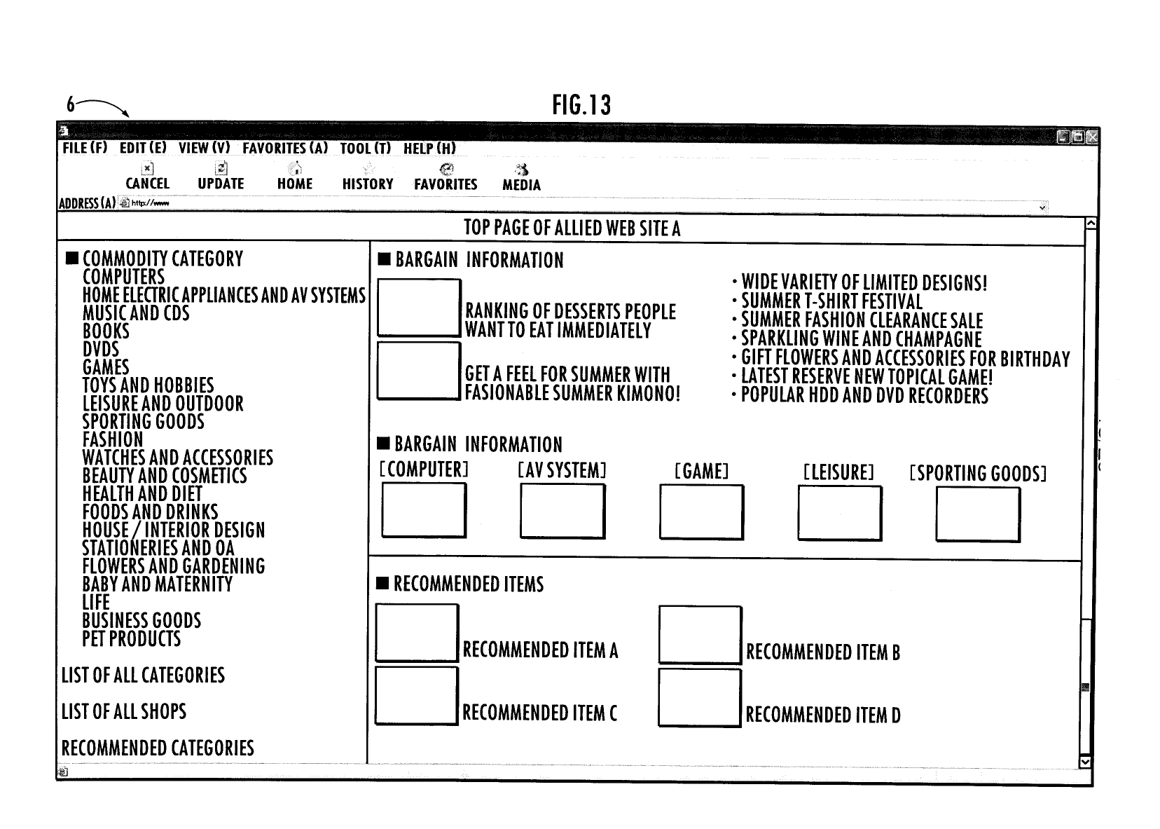

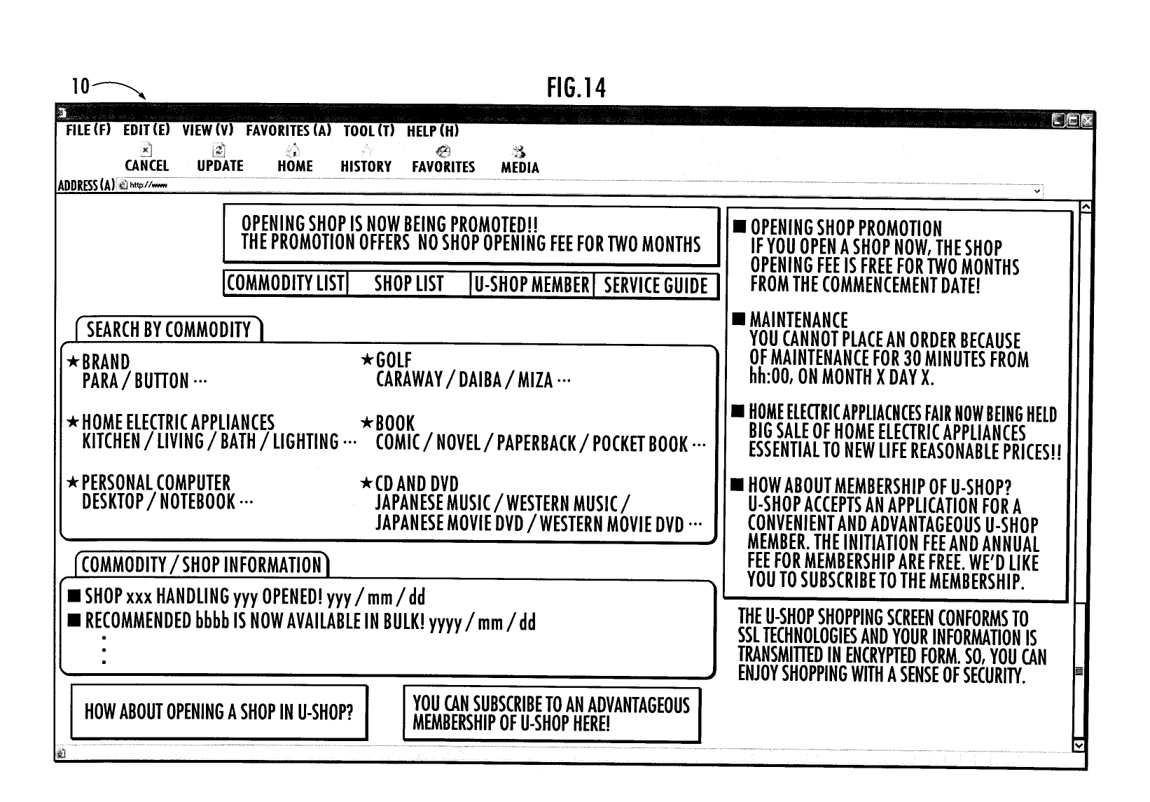

As examples of display of these commodity guide pages, FIG. 13, FIG. 14, and FIG. 15 show a screen of the allied site 6, a screen of the web site 10, and a screen 30A of the web site 30, respectively.

The shop terminal includes a personal computer (PC) and peripheral devices thereof: the personal computer stores a business application for use in performing a function of recording commodity information for each commodity to be sold which is generally traded at the shop and sales information and customer information processed based on the commodity information and updating the sales information or customer information based on ordered items from the customer, and a function of issuing various slips with reference to the sales information or customer information. In addition to this arrangement, the shop terminal of each of the affiliated shops A, B, and so on includes a transmitting section 26 for transmitting stock information 21 and image information 22 stored as commodity information in a memory of the PC or other storage means and a receiving section 27 for receiving order reception information transmitted from the virtual shop as describe later.

The number of the commodity trade assisting system 1, the relay devices 3, or the shop terminals can be one or more as described above. In addition, the number of the web sites and that of the allied sites are not limited to one, but a plurality of web sites or allied sites can be used or disposed according to the size (for example, the number of affiliated shops) of the entire system.

The commodity trade assisting system 1 includes: a communication unit 17 for directly or indirectly (via the relay device 3 in the system configuration shown in FIG. 12) communicating with the shop terminal of each of the affiliated shops A, B, and so on over the network; a database 16 which stores information on a single-controlled commodity transmitted as a commodity to be sold over the network of each affiliated shop from the shop terminal and received by the communication unit 17; and an application server AS which has a function of commodity report preparation means for preparing and posting explanation and other reports about the commodity shown on a commodity guide page of the virtual shop with reference to the commodity information, and a function of commodity information updating means for transmitting a signal representing a request to send back information on the commodity to be sold over the network of each affiliated shop at predetermined time intervals (thirty second intervals in general) from the communication unit 17 to the shop terminal, updating the information in the database 16 according to the information sent back in response to the request, receiving commodity order information from the virtual shop, and updating the information in the database 16 according to the order information.

The database 16 stores the above-mentioned stock information 11, the image information 12, and the order reception information 13 in a table format. In addition, it includes a category master (table) 14 in which the commodities to be sold are categorized by type or manufacturer and a shopping cart (table) 15 for use in temporarily storing order information transmitted from the virtual shop.

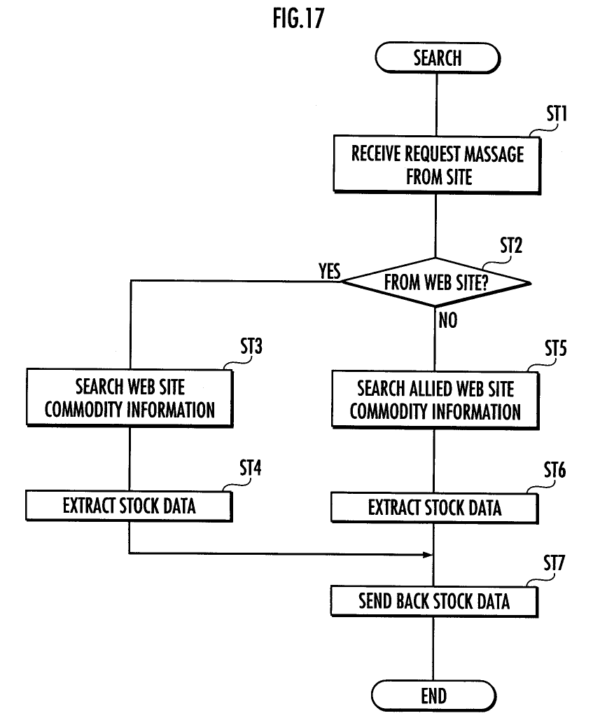

As shown in FIG. 18, the category master 14 consists of the following three types: a web site category master 14a; an allied site category master 14b; and a web-allied site category correspondence master 14c.

In the web site category master 14a, individual commodities are categorized (identified) by category of business (for example, “brand” representing a manufacturer), type (for example, “clock”), classification (for example, “watch”), manufacturer (name), and model (style).

In the allied web site category master 14b, the commodities are categorized (identified) for each allied site by different items from those of the web site, that is, category ID (for example, 10-digit number), type (for example, accessory, clock), classification (for example, “brand-name watch”), manufacturer (name), and model (style).

Therefore, the web-allied site category correspondence master 14c is provided to associate the web site with each allied site for one commodity. It includes the items of the web site category master 14a in the first half and the category IDs of the category master 14b of the allied sites A, B, and so on in the second half with the model names of the commodities placed therebetween.

Again in FIG. 12, the communication unit 17 includes a stock data processing section 18 and an image data processing section 19 for processing and transmitting stock data and image data directly or indirectly transmitted from the shop terminals of the affiliated shops A, B, and so on to each file of the stock information 11 and the image information 12 stored in the database 16 and an order reception data processing section 20 for transmitting the order reception information 13 sent from the virtual shop as order reception data to the affiliated shops.

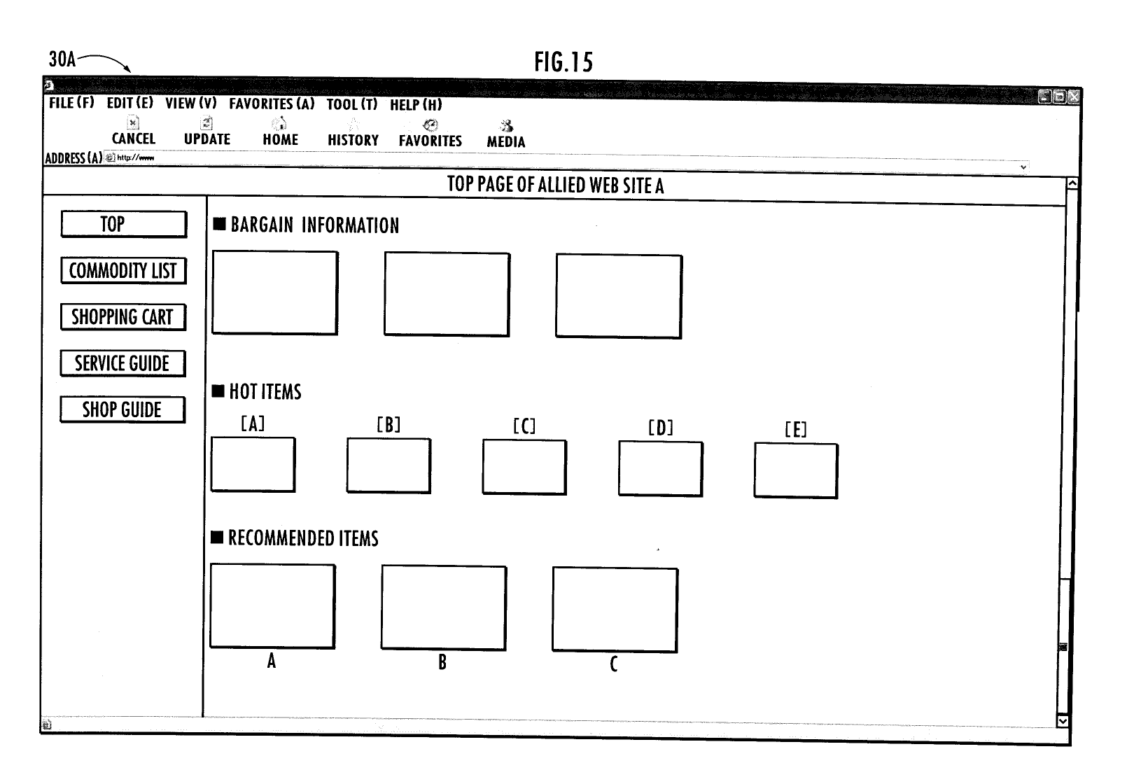

The function of the application server AS is composed of a computer program which causes the commodity trade assisting system 1 to perform “stock search” and “order processing” operations described later. As shown in FIG. 16, these operations include web site commodity information processing, allied site commodity information processing, web site order processing, and allied site order processing.

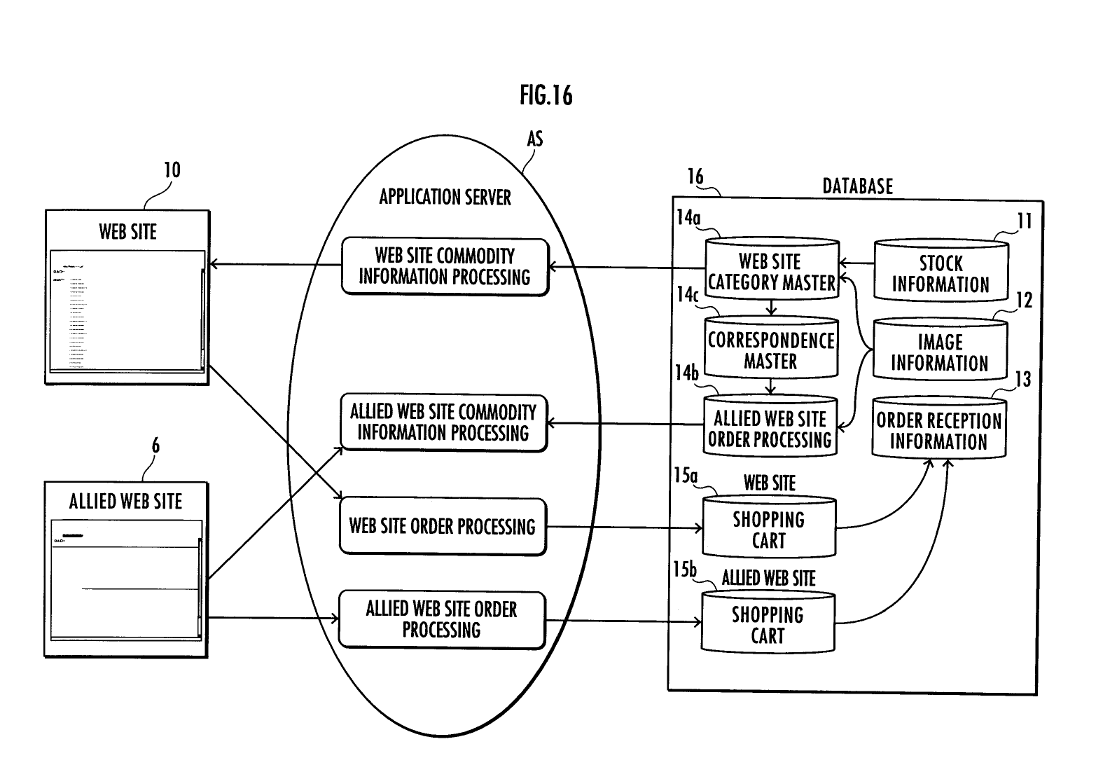

FIG. 17 shows a flowchart of the “stock search” operation of the application server AS. At first the operation starts “receiving a request message” (ST1), in which it is determined whether or not the message is sent from the web site (ST2). The request message includes a category as a keyword for use in identifying the commodity. As shown in FIG. 16, categories are classified into category of business (for example, “brand”), type (for example, “clock”), class (for example, “watch”), manufacturer, and model.

If the determination result of the above ST2 is “Yes,” the application server AS searches the web site commodity information (ST3). As shown in FIG. 18, this search is to search for a commodity category specified in the above message to extract the corresponding category with reference to the web site category master 14a. Then it extracts the commodity stock data of the web site based on the extracted category (ST4).

On the other hand, if the determination result of the above ST2 is “No”, the application server AS searches the allied site commodity information (ST5). As shown in FIG. 18, this search is to search for the category ID of each of the allied sites A, B, and so on of the commodity specified in the above message to extract the corresponding category IDs of the allied sites with reference to the web-allied site category correspondence master 14c, first, and then to search for the commodity category specified in the above message to extract the corresponding category with reference to the allied site category master 14b on the basis of the extracted category ID. Thereafter, the application server AS extracts commodity stock data of each allied site based on the extracted category ID (ST6).

The application server AS sends back the commodity stock data of the web site or allied site extracted in this manner to the web site or allied site requesting the data (ST7) and then terminates the search operation.

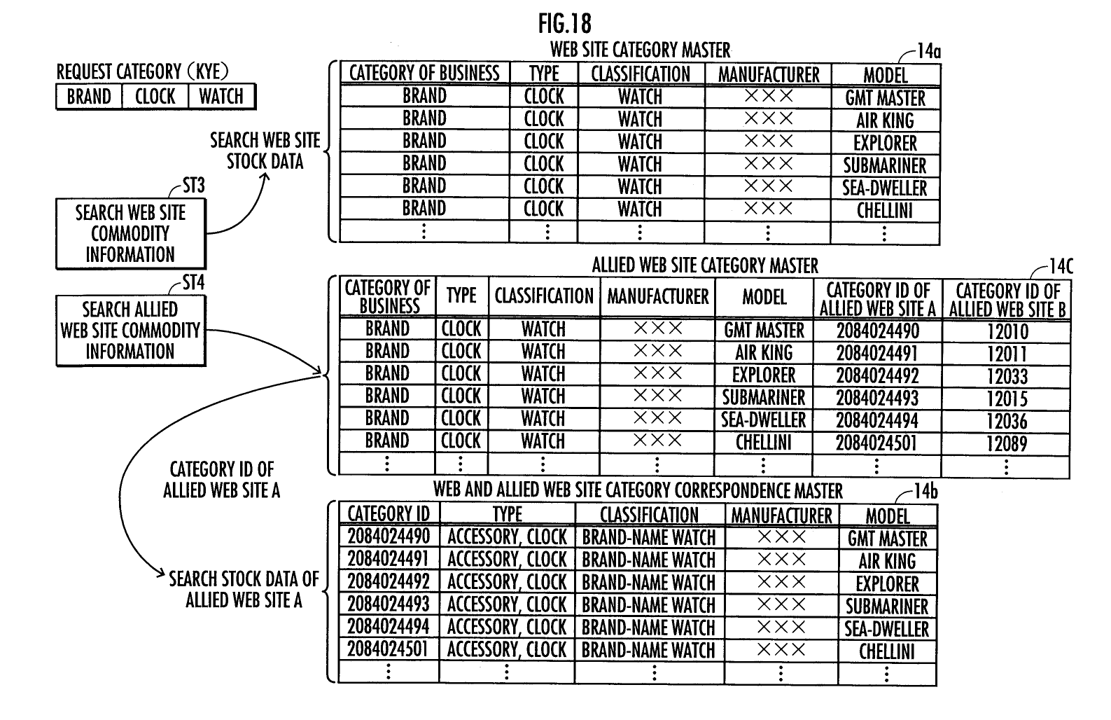

FIG. 19 shows a flowchart of the “order processing” operation of the application server AS. This operation is common between an order reception from the web site 10 and an order reception from the allied site 6.

First, the application server AS performs “stock information check” upon receiving an order of a commodity from the web site 10 or the allied site 6 (ST11). More specifically, it determines whether there is a stock of the commodity specified in the order information stored in the shopping cart 15 with reference to the stock information 11 (ST12). If the determination result is “available,” the application server AS gives OK to settlement of the corresponding commodity (the commodity can be traded) (ST13). If it is “not available”, the application server AS gives NG to settlement of the corresponding commodity (sold) (ST14). Thereafter, it updates the information of the shopping cart 15 (ST15) and terminates the operation.

Again in FIG. 12, the relay device 3 has the stock information 31, the image information 32, and the order reception information 33 synchronized with the commodity information of the affiliated shop B similarly to the stock information 11, the image information 12, and the order reception information 13 of the commodity trade assisting system 1, with the order reception information 33 storing order information transmitted from the shopping cart 35 of the web site 30. In addition, it has a function of storing sales information 34 of the affiliated shop B.

Furthermore, the relay device 3 includes a transmitting unit 36 which performs processing for transmitting the above information to the commodity trade assisting system 1 and a receiving unit 37 which performs processing for receiving commodity information such as stock information from the shop terminal of the affiliated shop B as described later. The transmitting unit 36 includes a stock data processing section, an image data processing section, and an order reception data processing section. The receiving unit 37 includes a stock data processing section, an image data processing section, an order reception data processing section, and a sales data processing section. The sales information of the affiliated shop B is received and stored in the sales data processing section of the receiving unit 37.

The following describes the operations of the commodity trade assisting system 1 and the relay device 3 constituting the commodity trade system shown in FIG. 12.

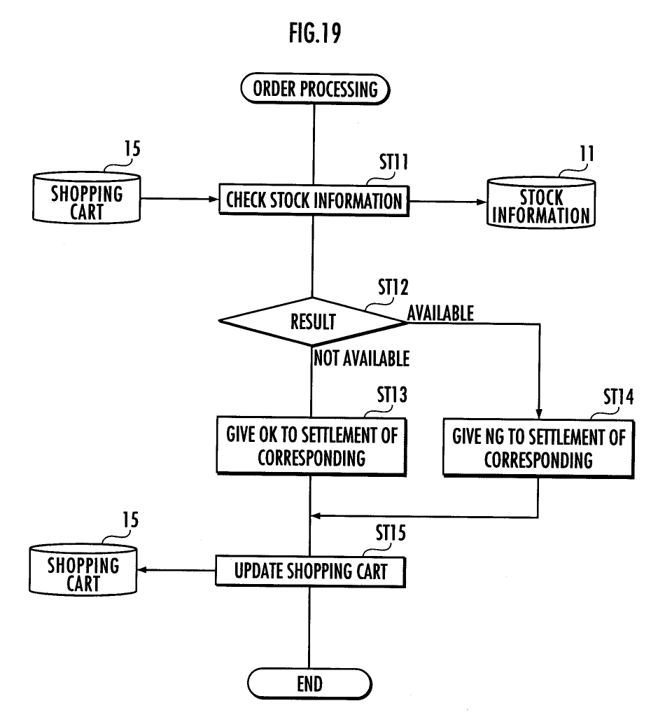

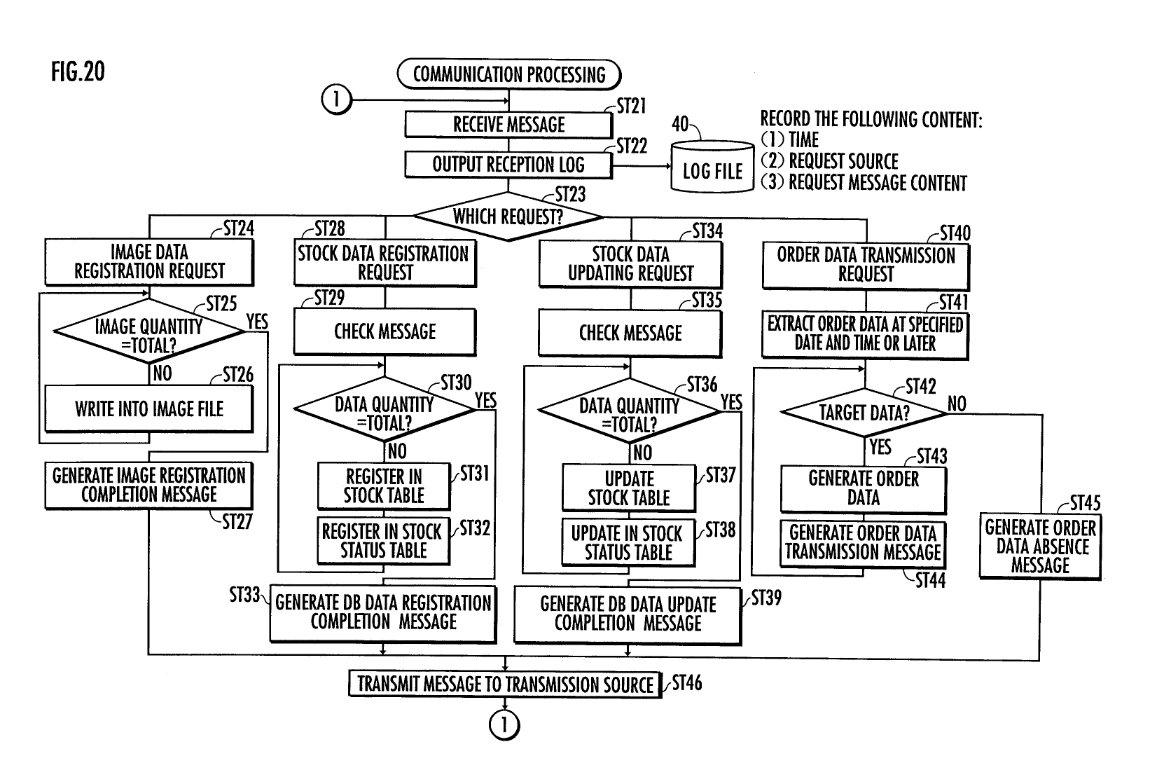

FIG. 20 shows a flowchart of an operating procedure for the communication processing performed by the communication unit 17 of the commodity trade assisting system 1 with the shop terminal PC or the relay device 3.

First, upon receiving a message transmitted from the shop terminal or the relay device 3 (ST21), the communication unit 17 outputs (records) the reception log to a log file 40 (ST22). The content of the record includes time, a request source, and a request message. Thereafter, it determines which of the following four requests (1) to (4) corresponds to the message (ST23). The following steps are performed according to the determination result.

(1) In the Case of the Message Determined to be an Image Data Registration Request (ST24)

The image data registration is to store the image information 22 of each commodity generated by the affiliated shop as the image information 12 to be posted on the site into the database 16 as described above. The above message includes one or more commodity images desired to be registered and therefore the image data processing section 19 of the communication unit 17 writes each image data into a file. More specifically, it checks the number of images included in the above message (ST25) and writes the image data into the image file until the total number of images is reached (ST26). Upon the completion of the writing, the image registration completion message is generated (ST27).

(2) In the Case of the Message Determined to be a Stock Data Registration Request (ST28)

The stock data registration is to store the stock information 21 of each commodity of the affiliated shop as the stock information 11 to be posted on the site into the database 16. The above message includes one or more commodity data. Therefore, after checking the message (ST29), the stock data processing section 18 of the communication unit 17 registers the commodity data into the stock table and also registers it into the stock status table indicating the stock status, namely the presence or absence of the stock for each commodity. More specifically, it checks the number of data of the commodities in stock included in the above message (ST30) and registers the commodity data into the stock table (ST31) and registers it into the stock status table (ST32) until the total number of data is reached. Upon the completion of the registration, the data registration completion message is generated (ST33).

(3) In the Case of the Message Determined to be a Stock Data Updating Request (ST34)

The stock data updating is to update the stock information 11 when a commodity is sold in the affiliated shop or the like. The above message includes one or more update data. Therefore, the message is checked, first (ST35), and then the stock data processing section 18 of the communication unit 17 registers the update data into the stock table and also registers it into the stock status table for each stock commodity. More specifically, it checks the number of update data included in the above message (ST36) and updates the stock table (ST37) and the stock status table (ST38) until the total number of update data is reached. Upon the completion of the update, the data update completion message is generated (ST39).

(4) In the Case of the Message Determined to be an Order Data Transmission Request (ST40)

The order data transmission is to transmit the order reception information 13 indicating the presence or absence of an order of a commodity posted on the site, namely whether the order of the commodity is placed, to the affiliated shop or the relay device 3. Upon receiving the transmission request, the order reception data processing section 20 of the communication unit 17 extracts data on ordered commodities received at the specified date and time or later from the order reception information 13 (ST41) and checks whether it is the object data, namely order data requested to be transmitted for each commodity (ST42). If the result is “Yes”, it generates the order reception information as order data (ST43) and generates an order data transmission message (ST44). On the other hand, unless the extracted data is the target data, it generates an order data absence message (ST45).

In any of the above cases (1) to (4), the communication unit 17 transmits a message generated at the final step (together with the generated order data in the case of (4)) to the shop terminal or the relay device 3 as being the transmission source (ST46), and then returns to the beginning (awaiting the message reception).

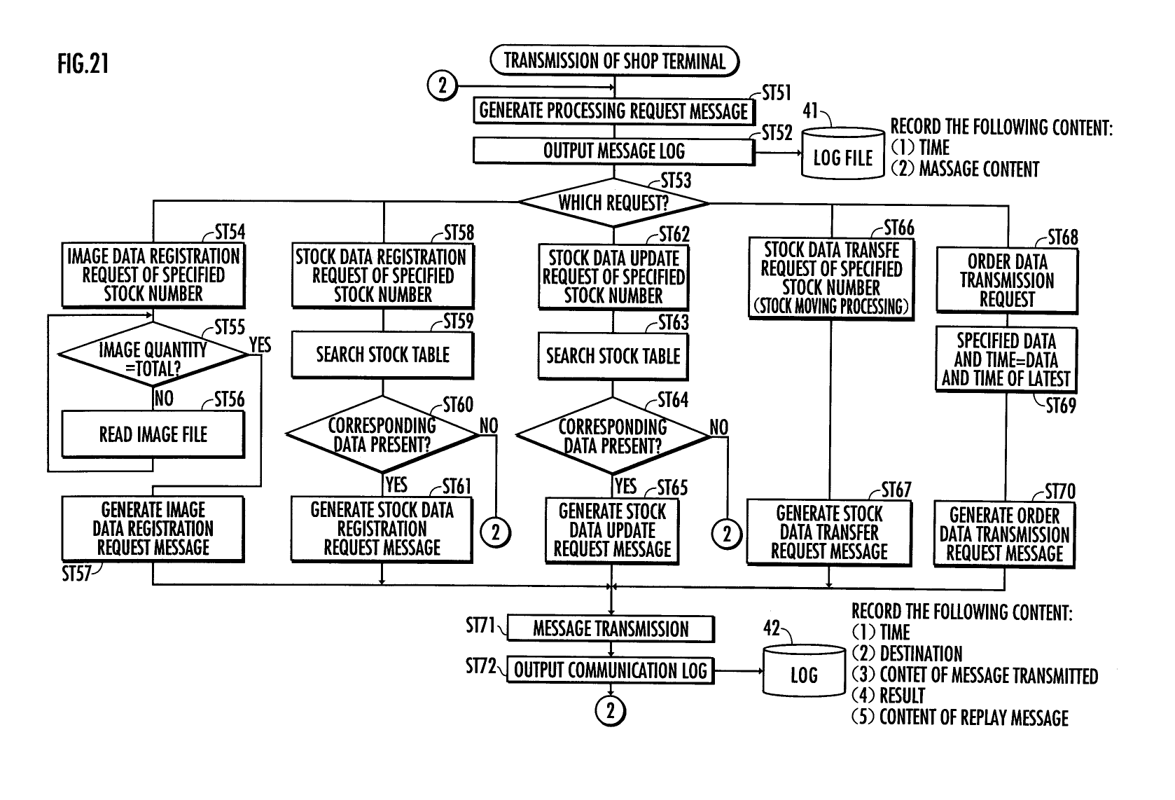

FIG. 21 shows a flowchart of a transmission processing performed by the transmitting section 26 of the shop terminal.

First, the transmitting section 26 generates a processing request message to be transmitted to the commodity trade assisting system 1 or the relay device 3 (ST51) and then outputs (records) a message log thereof to a log file 41 (ST52). The contents of the records include time and the message content. Thereafter, it checks which of the following requests (1) to (5) corresponds to the message (ST53) and performs the following steps according to the result.

(1) In the Case of the Message Checked to be an Image Data Registration Request Specified by Stock Number (ST54)

The transmitting section 26 reads an image file for each commodity image in order to transmit the image of the commodity desired to be posted on the site from the image information 22 of the commodity generated by the affiliated shop as described above. More specifically, it checks the number of images desired to be transmitted (ST55) and reads the image file until the total number of images is reached (ST56). Upon the completion of reading the total number of the images, it generates an image data registration request message (ST57).

(2) In the Case of the Message Checked to be a Stock Data Registration Request Specified by Stock Number (ST58)

For transmitting stock data desired to be posted on the site from the stock information 21 of the affiliated shop as described above, the transmitting section 26 searches the stock table (ST59) and checks the presence or absence of the corresponding data (ST60). If there is no corresponding data, it returns to the beginning. If there is the corresponding data, it generates a stock data registration request message (ST61).

(3) In the Case of the Message Checked to be a Stock Data Update Request Specified by Stock Number (ST62)

For updating the stock information as described above, the transmitting section 26 searches the stock table (ST63) and checks the presence or absence of the corresponding data (ST64). If there is no corresponding data, it returns to the beginning. If there is the corresponding data, it generates a stock data update request message (ST65).

(4) In the Case of the Message Checked to be a Stock Data Transfer Request Specified by Stock Number (ST66)

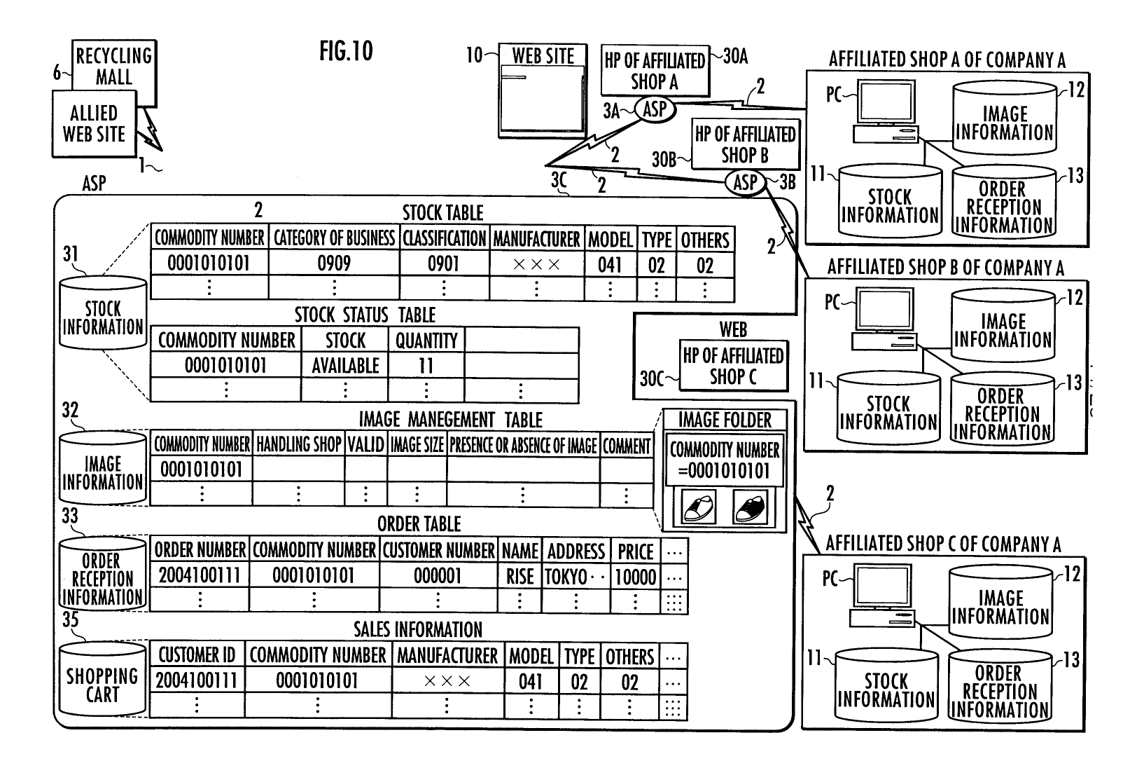

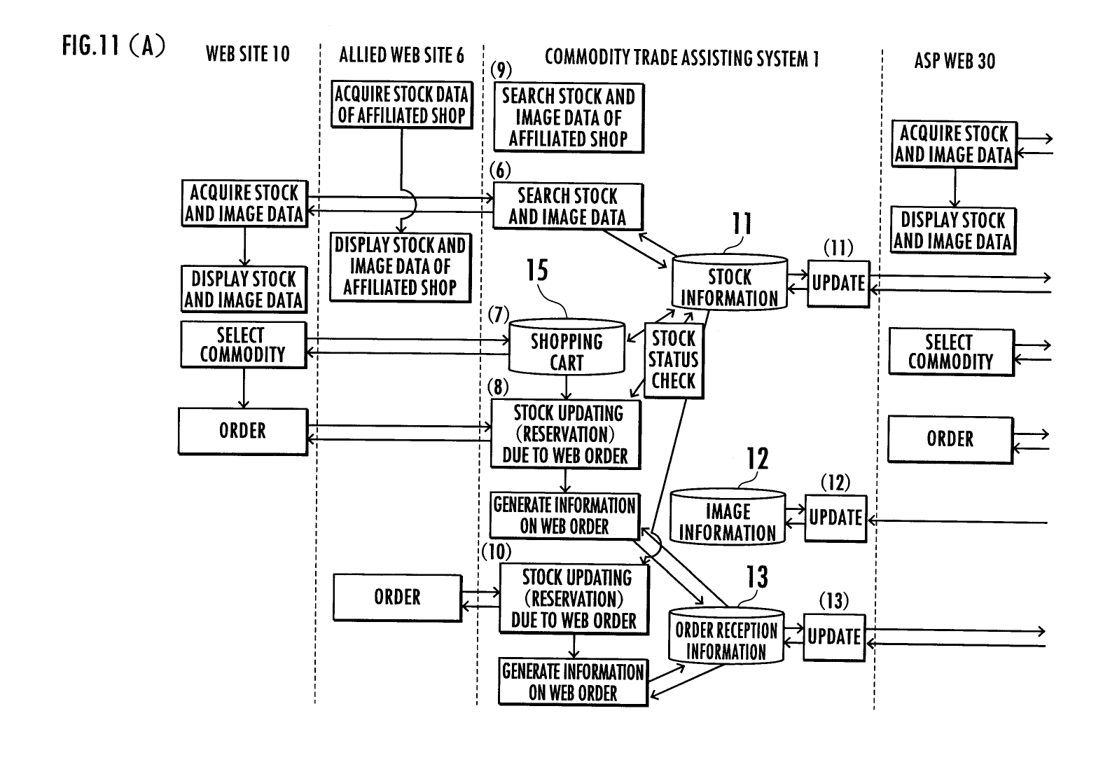

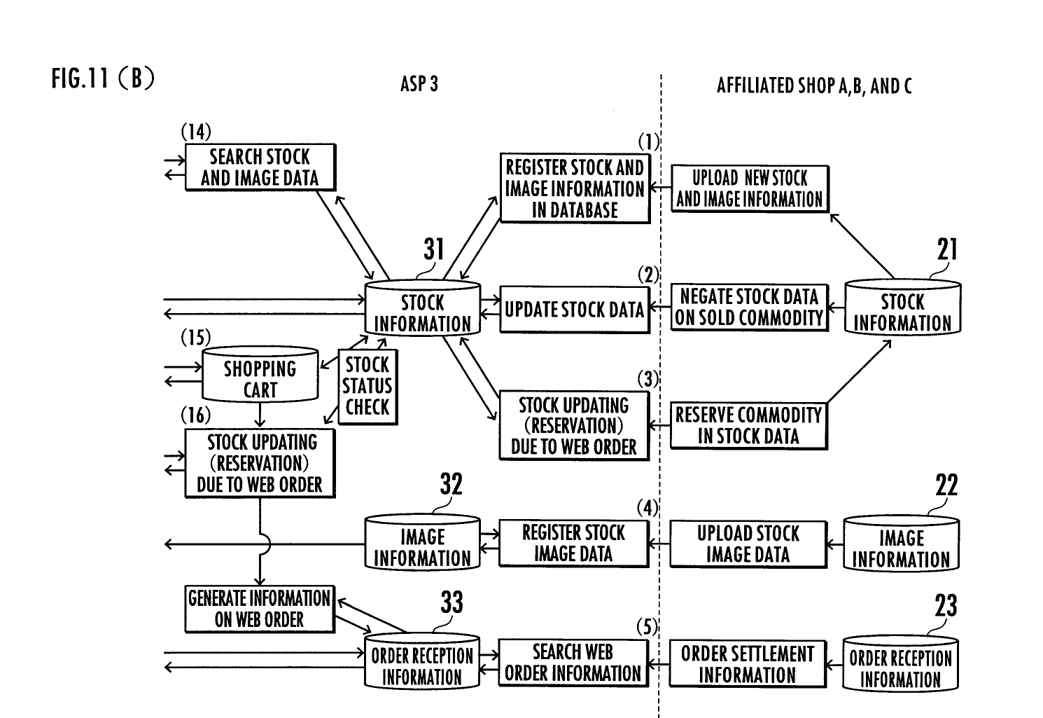

The transmitting section 26 transfers stock data when moving commodities in stock between a plurality of affiliated shops connected to the relay device 3 like the affiliated shop B shown in FIG. 10. For example, if the commodities in stock of the affiliated shop B are moved to the affiliated shop C, the shop terminal of the affiliated shop B generates a stock data transfer request message (ST67).

(5) In the Case of the Message Checked to be an Order Data Transmission Request (ST68)

For requesting the transmission of order reception information as described above, the transmitting section 26 sets the date and time of the latest order data in its own (of the shop terminal concerned) database as specified date and time (ST69), and generates an order data transmission request message (ST70).

In any of the above cases (1) to (5), the transmitting section 26 transmits a finally generated message (ST71), outputs (records) a communication log to a log file 42 (ST72), and then returns to the beginning. The contents recorded into the log file include time, a destination, a transmission message content, a result (response), and a response message content.

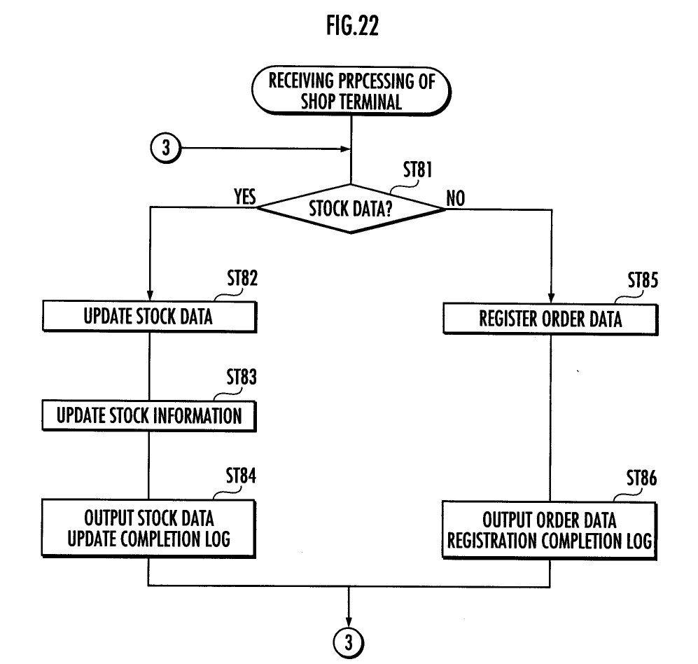

FIG. 22 shows a flowchart of receiving processing performed by the receiving section 27 of the shop terminal.

A signal received by the receiving section 27 represents data on the stock information or order information transmitted from the commodity trade assisting system 1 or the relay device 3. Therefore, at first the receiving section 27 determines whether or not the received data is stock data (ST81). If the stock data, it starts stock data update processing (ST82), updates its own stock information 21 with the received data (ST83), outputs (records) a stock data update completion log upon the completion (ST84), and then returns to the beginning.

On the other hand, if the result is order data, the receiving section 27 registers the received order data in the order reception information 23 (ST85). Upon the completion of the registration, it outputs (records) an order data registration completion log (ST86) and then returns to the beginning.

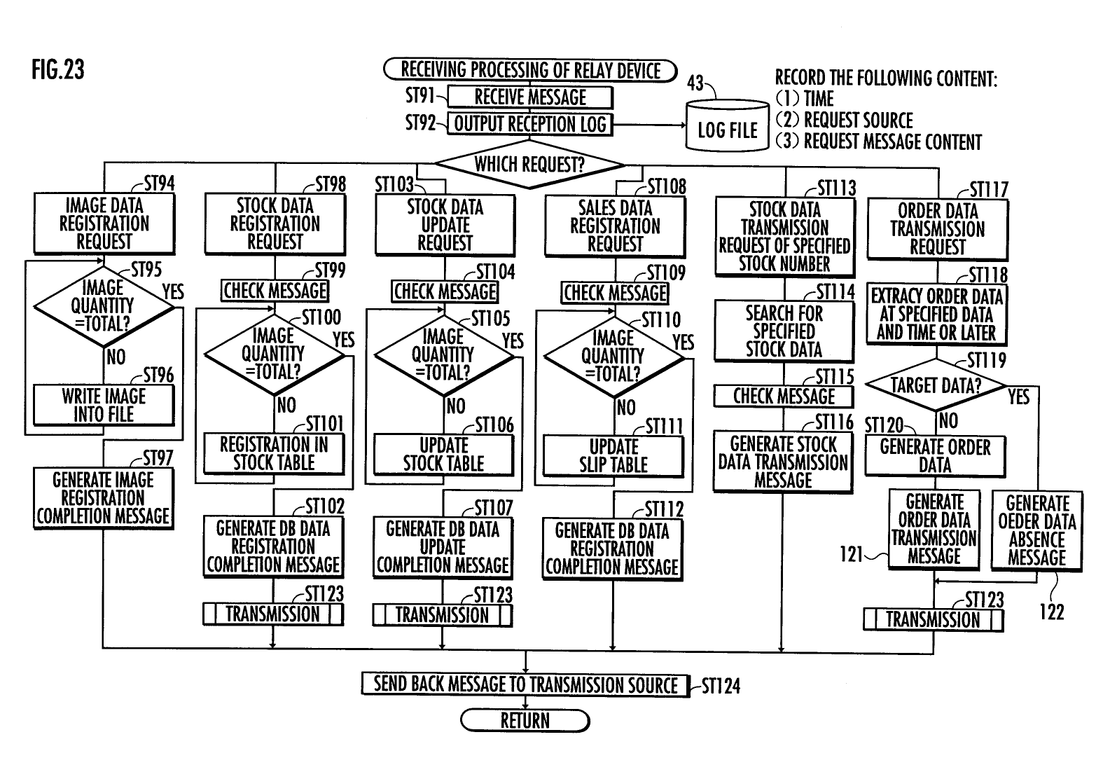

FIG. 23 shows a flowchart of receiving processing performed by the relay device 3 upon receiving a message from the shop terminal.

At first, upon receiving a message from the shop terminal or the commodity trade assisting system 1 (ST91), the receiving unit 37 outputs (records) its reception log to a log file 43 (ST92). The contents of the records include time, a request source, and a request message content. Thereafter, it determines which of the following six requests (1) to (6) corresponds to the message (ST93). It performs the following steps according to the determination result.

(1) In the Case of the Message Checked to be an Image Data Registration Request (ST94)

Similarly to the receiving processing of the communication unit 17 described above, the image data processing section of the receiving unit 37 writes image data into a file for each image included in the received message. More specifically, it checks the number of images included in the above message (ST95) and continues to write images into the image file until the total number of images is reached (ST96). Upon the completion of the writing, it generates an image registration completion message (ST97).

(2) In the Case of the Message Checked to be a Stock Data Registration Request (ST98)

After checking the received message including one or more commodity data (ST99), the stock data processing section registers the commodity data in the stock table for each commodity. More specifically, it checks the number of data of the commodities in stock included in the above message (ST100) and registers the commodity data in the stock table until the total number of data is reached (ST101). Upon the completion of the registration, it generates a data registration completion message (ST102). Thereafter, the transmitting unit 36 performs transmission described later (ST123). It should be noted that there is no stock status table here as in the communication unit 17 mentioned above.

(3) In the Case of the Message Checked to be a Stock Data Update Request (ST103)

After checking the message including one or more update data (ST104), the stock data processing section registers update data in the stock table for each commodity in stock. More specifically, it checks the number of update data included in the above message (ST105) and continues to update the stock table until the total number of update data is reached (ST106). Upon the completion of the update, it generates a data update completion message (ST107). Thereafter, the transmitting unit 36 performs the transmission described later (ST123).

(4) In the Case of the Message Checked to be a Sales Data Registration Request (ST108)

The relay device 3 is provided with a database for use in recording sales data of the affiliated shop having a shop terminal connected to the relay device 3 as sales information 34. Therefore, the sales data processing section checks the message including one or more sales data transmitted from the shop terminal of the affiliated shop (ST109) and updates a slip table with the sales data. More specifically, the sales data processing section checks the number of sales data included in the above message (ST110) and continues to update the slip table until the total number of the sales data is reached (ST111). Upon the completion of the updating, it generates a data registration completion message (ST112).

(5) In the Case of the Message Checked to be a Stock Data Transmission Request Specified by Stock Number (ST113)

The relay device 3 searches the specified stock data in order to transmit the stock data requested by the affiliated shop (ST114), checks the message (ST115), and generates a transmission message of the corresponding stock data (ST116).

(6) In the Case of the Message Checked to be an Order Data Transmission Request (ST117)

Similarly to the receiving processing of the above communication unit 17, the order reception data processing section extracts data of commodities ordered on the specified date and later from the order reception information 33 (ST118) and checks whether the data is the target data for each commodity (ST119). If the result is “Yes”, it generates order reception information as order data (ST120) and generates an order data transmission message (ST121). On the other hand, unless the data is the target data, it generates an order data absence message (ST122). In either case, the transmitting unit 36 performs the following transmission processing (ST123).

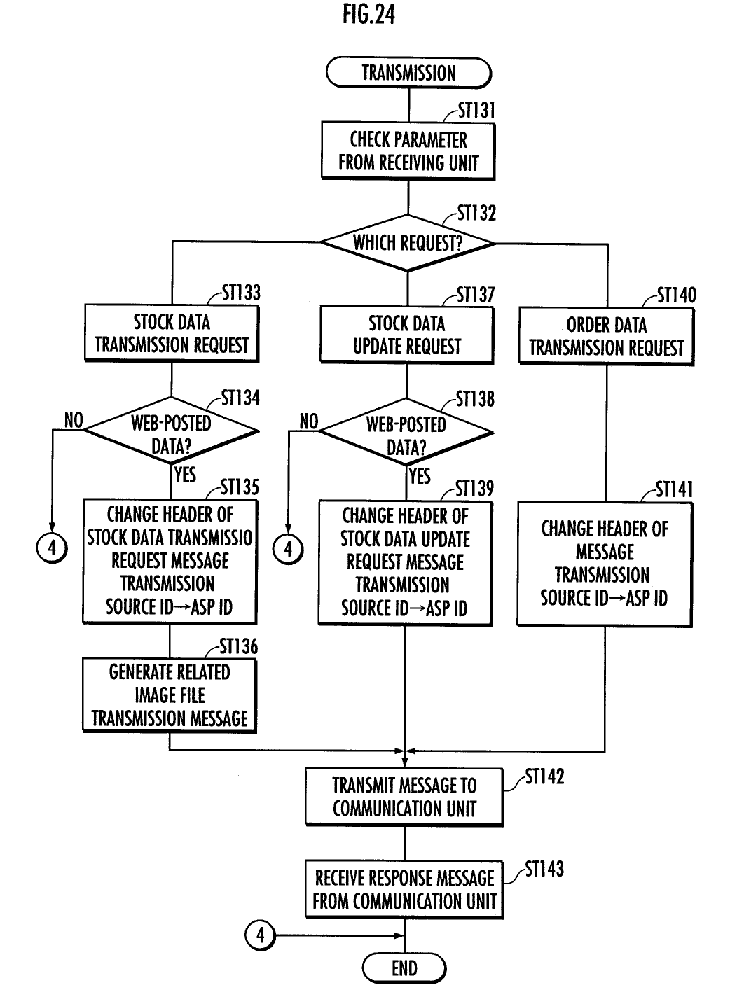

FIG. 24 shows a flowchart showing the transmission processing in ST123.

First, the transmitting unit 36 checks a parameter received from the receiving unit 37 (ST131) and determines which of the above requests (1), (2), and (3) corresponds to the message (ST132). It performs the following steps according to the determination result.

(1) In the Case of the Message Checked to be a Stock Data Transmission Request (ST133)

As describe above, the transmitting unit 36 checks whether the data included in the above message is web-posted data (ST134) in order to transmit the stock information 21 of the affiliated shop as stock information to be posted on the web site 10 to the commodity trade assisting system 1. If the result is “No”, the processing terminates. If it is “Yes”, the transmitting unit 36 changes the transmission source ID of the header section of the stock data transmission request message to a relay ID (ID of the relay device 3) (ST135) and generates a related image file transmission message (ST136).

(2) In the Case of the Message Checked to be a Stock Data Update Request (ST137)

For updating the stock information 11 when the commodity is sold in affiliated shop or the like as described above, the transmitting unit 36 checks whether the data included in the above message is web-posted data (ST138). If the result is “No”, the processing terminates. If it is “Yes”, the transmitting unit 36 changes the transmission source ID of the header section of the stock data update request message to the relay ID (ID of the relay device 3) (ST139).

(3) In the Case of the Message Checked to be an Order Data Transmission Request (ST140)

The order data transmission is to transmit the order reception information 13 of the commodity trade assisting system 1 to the affiliated shop via the relay device 3. In this case, the transmitting unit 36 changes the transmission source ID of the header section of the transmission request message to the relay ID (ID of the relay device 3) (ST141).

After the processing of the above requests (1) to (3), the transmitting unit 36 transmits a message to the communication unit 17 of the commodity trade assisting system 1 (ST142) and receives a response message from the communication unit 17 (ST143), and the processing terminates.

Again in FIG. 23, in any of the above cases (1) to (6), the message generated in the final step is transmitted from the transmitting unit 36 to the transmission source (ST124) and then returns to the beginning (awaiting reception of a message).

The above operations of the commodity trade assisting system 1 and those of the relay device 3 can be processed more rapidly by being distributed to a plurality of servers according to the content of the processing.

While the preferred embodiments have been described above, the present invention is not limited thereto, but any commodity trade assisting system may be used if it can achieve the above object.

1. A commodity trade assisting system for assisting a shop in exhibiting a commodity traded at the shop in a virtual shop and managing it, comprising:
communication means for communicating with a shop terminal which records and manages information on the commodity over a network;
a database for storing commodity information sent from the terminal as information on the commodity of the shop to be sold over the network and received by the communication means;
commodity report preparation means for preparing and posting explanation and other reports about the commodity shown on a commodity guide page of the virtual shop with reference to the commodity information sent from the terminal and received by the communication means; and
commodity information updating means for transmitting a signal representing a request to send back information on the commodity of the shop to be sold over the network at predetermined time intervals from the communication means to the terminal, updating the information in the database according to the information sent back from the terminal in response to the request, receiving an order information of the commodity shown on the commodity guide page and ordered, and updating the information in the database according to the order information.

2. The commodity trade assisting system according to claim 1, wherein the commodity is a single-controlled commodity and the commodity guide page is provided in an existing online web site and a web site operated by the commodity trade assisting system.

3. The commodity trade assisting system according to claim 1, further comprising means for storing image information on the commodity associated with data on the commodity exhibited in the virtual shop by the shop,
wherein the commodity report preparation means has a function of posting the image information in the virtual shop.

4. The commodity trade assisting system according to claim 1, further comprising a relay device connected to the shop terminal over the network, wherein the relay device is used to perform a function of posting the commodity information of each shop in the virtual shop and a function of searching stock information in real time or making settlement.

5. A computer program for performing functions of assisting a shop in exhibiting a commodity traded at the shop in a virtual shop and managing it by using a computer, the program performing the functions of:
communicating with a shop terminal which records and manages information on the commodity over a network;
storing commodity information sent from the terminal as information on the commodity of the shop to be sold over the network and received by the communicating function;
preparing and posting explanation about the commodity shown on a commodity guide page of the virtual shop and other reports with reference to the commodity information sent from the terminal and received by the communicating function; and
transmitting a signal representing a request to send back information on the commodity of the shop to be sold over the network at predetermined time intervals to the terminal, updating information in a database according to the information sent back from the terminal in response to the request, receiving information on an order of the commodity shown on the commodity guide page and ordered, and updating the information in the database according to the order information.

6. The computer program according to claim 5, wherein the commodity is a single-controlled commodity.

7. The commodity trade assisting system according to claim 2, further comprising means for storing image information on the commodity associated with data on the commodity exhibited in the virtual shop by the shop,
wherein the commodity report preparation means has a function of posting the image information in the virtual shop.

8. The commodity trade assisting system according to claim 2, further comprising a relay device connected to the shop terminal over the network, wherein the relay device is used to perform a function of posting the commodity information of each shop in the virtual shop and a function of searching stock information in real time or making settlement.

9. The commodity trade assisting system according to claim 3, further comprising a relay device connected to the shop terminal over the network, wherein the relay device is used to perform a function of posting the commodity information of each shop in the virtual shop and a function of searching stock information in real time or making settlement.
